(19) United States
(12) Patent Application Publication
(10) Pub. No.: US 2020/0104528 A1
(43) Pub. Date: Apr. 2, 2020

(54) DATA PROCESSING METHOD, DEVICE AND SYSTEM

(71) Applicant: Alibaba Group Holding Limited, Grand Cayman (KY)

(72) Inventor: Yingfang Fu, Hangzhou (CN)

(73) Assignee: Alibaba Group Holding Limited

(21) Appl. No.: 16/586,463

(22) Filed: Sep. 27, 2019

(30) Foreign Application Priority Data
Sep. 28, 2018 (CN) 201811143031.7

(51) Int. Cl. G06F 21/62; G06F 21/60; G06F 21/12

(52) U.S. Cl. CPC G06F 21/6245; G06F 21/123; G06F 21/602

(57) ABSTRACT

A method including receiving, by a security chip, a user key in plaintext request sent by a cryptographic operation chip, wherein the user key in plaintext is used for processing to-be-processed data; acquiring, by the security chip, a storage key in plaintext for decrypting a user key in ciphertext; decrypting, by the security chip, the user key in ciphertext by using the storage key in plaintext to obtain the user key in plaintext; and sending, by the security chip, the user key in plaintext back to the cryptographic operation chip. The present disclosure solves the technical problems in the conventional techniques of how to guarantee the security of a user key and how to prevent its exposure during transmission, such that the user key may be securely used to process user data.

### CROSS REFERENCE TO RELATED PATENT APPLICATIONS

This application claims priority to Chinese Patent Application No. 201811143031.7, filed on 28 Sep. 2018 and entitled “DATA PROCESSING METHOD, DEVICE AND SYSTEM,” which is incorporated herein by reference in its entirety.

### TECHNICAL FIELD

The present disclosure relates to the field of cryptographic operations, and, more particularly, to data processing methods, devices and systems.

### BACKGROUND

With the popularity of the Internet, electronic communication is increasingly widely applied. However, information security has significantly become the main issue in electronic communication. With respect to information security, there are many ways to reduce the possibility of information being stolen, tampered with, or replaced. For example, data may be encrypted. During data transmission between two information interaction parties, the transmitting party at first encrypts the data and then transmits the encrypted data to the receiving party. The receiving party then needs to decrypt the received encrypted information to obtain original data output by the transmitting party, thus effectively preventing data from being stolen, tampered with, or replaced by a third party during data transmission.

In conventional encryption and decryption techniques, an encryption algorithm and a decryption algorithm corresponding thereto may be used to implement data encryption and decryption. For example, a trusted high-speed data encryption card (THSDEC) is used for encryption. However, when a user key is needed to encrypt and/or decrypt data, i.e., during encryption of to-be-encrypted data and/or decryption of to-be-decrypted data, the security level is low. For example, problems of how to guarantee the security of the user key and how to obtain the user key through interaction with a board card need to be solved, so as to prevent exposure of the user key during internal storage or external transmission, such that the user key may be securely used to encrypt and/or decrypt user data.

No effective solutions for the abovementioned problems have been provided.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

The example embodiments of the present disclosure provide data processing methods, devices and systems to at least solve the technical problems in the conventional techniques of how to guarantee the security of a user key and how to prevent its exposure during transmission, such that the user key may be securely used to process user data.

According to an example embodiment of the present disclosure, a data processing method is provided, which comprises: receiving, by a security chip, a request for a user key in plaintext sent by a cryptographic operation chip, wherein the user key in plaintext is used for processing to-be-processed data, and the processing to-be-processed data comprises encrypting and/or decrypting the to-be-processed data; acquiring, by the security chip, a storage key in plaintext (or decryption key in plaintext) for decrypting a user key in ciphertext; decrypting, by the security chip, the user key in ciphertext by using the storage key in plaintext to obtain the user key in plaintext; and sending, by the security chip, the user key in plaintext back to the cryptographic operation chip.

According to an example embodiment of the present disclosure, a data processing method is also provided, which comprises: receiving, by a cryptographic operation chip, a data processing request; acquiring, by the cryptographic operation chip, to-be-processed data and a user key in ciphertext; loading, by the cryptographic operation chip, the user key in ciphertext to a security chip to request the security chip for the user key in plaintext; receiving, by the cryptographic operation chip, the user key in plaintext fed back by the security chip, wherein the user key in plaintext is obtained after the security chip decrypts the user key in ciphertext by using a storage key in plaintext; processing, by the cryptographic operation chip, the to-be-processed data by using the user key in plaintext to obtain a processing result, wherein the processing the to-be-processed data comprises encrypting and/or decrypting the to-be-processed data; and sending, by the cryptographic operation chip, the processing result back in response to the data processing request.

According to an example embodiment of the present disclosure, a data processing method is also provided, which comprises: receiving, by a cryptographic operation chip, a data processing request; acquiring, by the cryptographic operation chip, to-be-processed data and a user key in ciphertext; loading, by the cryptographic operation chip, the user key in ciphertext to a security chip to request the security chip for the user key in plaintext; acquiring, by the security chip, a storage key in plaintext for decrypting the user key in ciphertext; decrypting, by the security chip, the user key in ciphertext by using the storage key in plaintext to obtain the user key in plaintext; sending, by the security chip, the user key in plaintext back to the cryptographic operation chip; processing, by the cryptographic operation chip, the to-be-processed data by using the user key in plaintext to obtain a processing result, wherein the processing on the to-be-processed data comprises encrypting and/or decrypting the to-be-processed data; and sending, by the cryptographic operation chip, the processing result back in response to the data processing request.

According to an example embodiment of the present disclosure, a data processing device applied in a security chip is also provided, which comprises: a first receiving module configured to receive a request for user key in plaintext sent by a cryptographic operation chip, wherein a user key in plaintext is used for processing to-be-processed data, and the processing the to-be-processed data comprises encrypting and/or decrypting the to-be-processed data; a first acquisition module configured to acquire a storage key in plaintext for decrypting a user key in ciphertext; a first decryption module configured to decrypt the user key in ciphertext by using the storage key in plaintext to obtain the user key in plaintext; and a first feedback module configured to send the user key in plaintext back to the cryptographic operation chip.

According to an example embodiment of the present disclosure, a data processing device applied in a cryptographic operation chip is also provided, which comprises: a second receiving module configured to receive a data processing request; a second acquisition module configured to acquire to-be-processed data and a user key in ciphertext; a loading module configured to load the user key in ciphertext to a security chip, so as to ask the security chip for a user key in plaintext; a third receiving module configured to receive the user key in plaintext fed back by the security chip, wherein the user key in plaintext is obtained after the security chip decrypts the user key in ciphertext by using a storage key in plaintext; a second decryption module configured to process the to-be-processed data by using the user key in plaintext to obtain a processing result, wherein the processing on the to-be-processed data comprises encrypting and/or decrypting the to-be-processed data; and a second feedback module configured to send the processing result back in response to the data processing request.

According to an example embodiment of the present disclosure, a data processing system is also provided, which comprises a cryptographic operation chip and a security chip, wherein the cryptographic operation chip is configured to receive a data processing request; acquire to-be-processed data and a user key in ciphertext; and load the user key in ciphertext to the security chip to ask the security chip for a user key in plaintext; the security chip is configured to acquire a storage key in plaintext for decrypting the user key in ciphertext; decrypt the user key in ciphertext by using the storage key in plaintext to obtain the user key in plaintext; and send the user key in plaintext back to the cryptographic operation chip; and the cryptographic operation chip is further configured to process the to-be-processed data by using the user key in plaintext to obtain a processing result; and send the processing result back in response to the data processing request, wherein the processing on the to-be-processed data comprises encrypting and/or decrypting the to-be-processed data.

According to an example embodiment of the present disclosure, a computer storage medium is also provided, which comprises a stored program, wherein when the program runs, a device in which the storage medium is located is controlled to perform the data processing method according to any one of the above-described items.

According to an example embodiment of the present disclosure, a processor is also provided, wherein the processor is configured to run a program, and when the program runs, the data processing method according to any one of the above-described items is performed.

According to an example embodiment of the present disclosure, a computing device is also provided, which comprises at least one processor and a memory storing program instructions, wherein the program instructions are adapted to be executed by the at least one processor and are used to perform the data processing method according to any one of the above-described items.

In the example embodiments of the present disclosure, a security chip receives a request for user key in plaintext sent by a cryptographic operation chip, wherein the user key in plaintext is used for processing to-be-processed data, and the processing to-be-processed data comprises encrypting and/or decrypting the to-be-processed data; the security chip acquires a storage key (or decryption key) in plaintext for decrypting the user key in ciphertext, decrypts the user key in ciphertext by using the storage key in plaintext to obtain the user key in plaintext, and then sends the user key in plaintext back to the cryptographic operation chip. By processing a user key in plaintext, the user key in plaintext is securely transmitted and securely used to process to-be-processed data. Thus, a technical effect of effectively enhancing data processing security is achieved, and the technical problems in the conventional techniques of how to guarantee the security of a user key and how to prevent its exposure during transmission are solved, such that the user key is securely used to process user data.

### BRIEF DESCRIPTION OF THE DRAWINGS

The accompanying drawings described herein are used for providing further understanding of the present disclosure and constitute a part of the present disclosure. The example embodiments of the present disclosure and description thereof are used for illustrating the present disclosure, and do not constitute a limitation to the present disclosure. In the drawings:

FIG. 1 is a block diagram of a hardware structure of a computer terminal (or a mobile device) for implementing a data processing method;

FIG. 2 is a flowchart of a data processing method according to Example embodiment 1 of the present disclosure;

FIG. 3 is a flowchart of another data processing method according to Example embodiment 1 of the present disclosure;

FIG. 4 is a flowchart of still another data processing method according to Example embodiment 1 of the present disclosure;

FIG. 5 is a structural block diagram of a THSDC according to Example embodiment 1 of the present disclosure;

FIG. 6 is a structural block diagram of a trusted computing chip according to Example embodiment 1 of the present disclosure;

FIG. 7 is a structural block diagram of a Field-Programmable Gate Array (FPGA) chip according to Example embodiment 1 of the present disclosure;

FIG. 8 is a flowchart of a method for protecting data decryption based on a THSDC according to Example embodiment 1 of the present disclosure;

FIG. 9 is a flowchart of a method for protecting data encryption based on a THSDC according to Example embodiment 1 of the present disclosure;

FIG. 10 is a flowchart of a data processing method according to Example embodiment 2 of the present disclosure;

FIG. 11 is a flowchart of a data processing method according to Example embodiment 3 of the present disclosure;

FIG. 12 is a schematic structural diagram of a data processing device according to Example embodiment 4 of the present disclosure;

FIG. 13 is a schematic structural diagram of a data processing device according to Example embodiment 5 of the present disclosure;

FIG. 14 is a schematic structural diagram of a data processing system according to Example embodiment 6 of the present disclosure; and

FIG. 15 is a structural block diagram of a computer terminal according to an example embodiment of the present disclosure.

### DETAILED DESCRIPTION

To enable those of ordinary skill in the art better understand the solutions of the present disclosure, the technical solutions in the example embodiments of the present disclosure will be clearly and completely described below in combination with the accompanying drawings in the example embodiments of the present disclosure. Apparently, the described example embodiments merely represent a part, instead of all, of the example embodiments of the present disclosure. All other example embodiments obtained by those skilled in the art based on the example embodiments of the present disclosure without making inventive efforts should fall within the scope of protection of the present disclosure.

It should be noted that the terms “first,” “second,” etc. in the description, claims and drawings of the present disclosure are used to distinguish similar objects, and not necessarily to describe a particular order or sequence. It should be understood that data used as such may be interchanged under appropriate circumstances, so that the example embodiments of the present disclosure described herein may be implemented in an order other than the order illustrated or described herein. In addition, the terms “comprise/include” and “have” as well as any of their variations are intended to cover non-exclusive inclusion. For example, a process, method, system, product, or device including a series of steps or units are not necessarily limited to the steps or units clearly listed but may include other steps or units not clearly listed in or inherent to the process, method, product, or device.

First, some nouns or terms used in describing the example embodiments of the present disclosure are explained as follows:

A Trusted Platform Module/Trusted Platform Control Module (TPM/TPCM) is a security chip for guaranteeing integrity and authenticity of evidence and is forcibly bound to a computing platform generally via a physical manner.

A Field-Programmable Gate Array (FPGA) is specifically a semi-customized circuit and may implement different logic gate functions by changing connection between logic blocks, wherein the logic blocks and the connection therebetween may be changed according to designs, thus implementing a programmable function.

A Trusted high-speed Data Encryption Card (THSDEC or THSDC) is a data encryption card that may be trusted.

### Example Embodiment 1

According to the example embodiment of the present disclosure, a method example embodiment of a data processing method is also provided. It should be noted that steps illustrated by the flowcharts in the accompanying drawings may be executed in a computer system including a set of computer executable instructions. Moreover, although a logical order is shown in the flowcharts, in some cases, the shown or described steps may also be executed in an order other than the order described herein.

The method example embodiment provided by Example embodiment 1 of the present disclosure may be implemented in a mobile terminal, or a computer terminal or a similar computing device.

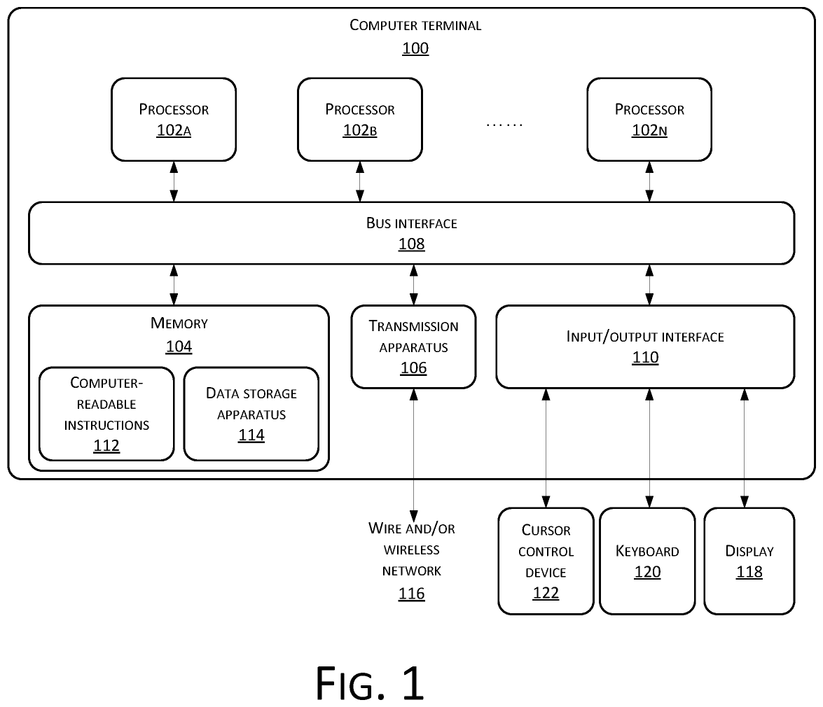

FIG. 1 shows a block diagram of hardware configuration of a computer terminal (or mobile device) for implementing a method for measurement processing of a cryptographic operation.

As shown in FIG. 1, a computer terminal 100 (such as a mobile device) may include one or more processors (shown as 102a, 102b, . . . , 102n in FIG. 1, wherein n may be any integer) (the processor(s) 102 may include, but is not limited to, a processing apparatus such as a microprocessor (MCU) or a programmable logic device (FPGA)), a memory 104 configured to store data, and a transmission apparatus 106 for communication functions. In addition, the computer terminal 100 may also include: a bus interface 108, an input/output interface (I/O interface) 110. The bus interface 108 transmits data between the processor 102, the memory 104, the transmission apparatus 106, and the input/output interface 110. For example, a universal serial bus (USB) port may be included as one of the ports of the I/O interface 110. The computer terminal 100 may also include a network interface, a power supply and/or a camera (not shown in FIG. 1). It will be understood by those skilled in the art that the structure shown in FIG. 1 is merely illustrative and does not limit the structure of the above electronic device. For example, the computer terminal 100 may also include more or fewer components than those shown in FIG. 1 or have a configuration different from that shown in FIG. 1.

It should be noted that the one or more processors 102 and/or other data processing circuits may generally be referred to as “data processing circuits” in the present disclosure. The data processing circuit may be embodied completely or partially as software, hardware, firmware or any other combination. Moreover, the data processing circuit may be a single, independent determining module, or incorporated completely or partially into any of other elements in the computer terminal 100. As referred to in the example embodiment of the present disclosure, the data processing circuit works as a processor to control, e.g., selection of a variable resistance terminal path connected to the interface.

The memory 104 may be configured to store software programs and modules of application software, such as computer-readable instructions 112 or data storage apparatus 114 corresponding to the file processing method in the example embodiment of the present disclosure. The processor 102 executes the software programs and modules stored in the memory 104, thus performing various functional applications and data processing, that is, implementing the file processing method. The memory 104 may include a high-speed random-access memory and may also include a non-volatile memory, such as one or more magnetic storage apparatuses, a flash memory, or other non-volatile solid-state memories. In some examples, the memory 104 may further include memories placed remote to the processor 102. These remote memories may be connected to the computer terminal 100 over a network. Examples of the network include, but are not limited to, the Internet, an intranet, a local area network, a mobile communication network, and a combination thereof.

The transmission apparatus 106 is configured to receive or send data via a network. A specific example of the network may include a wire and/or wireless network 116 provided by a communication provider of the computer terminal 100. In one example, the transmission apparatus 106 includes a Network Interface Controller (NIC) that may be connected to other network devices through a base station to communicate with the Internet. In one example, the transmission apparatus 106 may be a Radio Frequency (RF) module for communicating with the Internet wirelessly.

The input/out interface interacts with one or more peripheral device such as a display 118, a keyboard 120, and a cursor control device 122 such as a mouse.

The display 118 may be, for example, a touch screen-type liquid crystal display (LCD) that allows a user to interact with a user interface of the computer terminal 100.

The block diagram of the hardware structure shown in FIG. 1 may serve as both an exemplary block diagram of the computer terminal 100 (or the mobile device) and an exemplary block diagram of the server. In an alternative example embodiment, the computer terminal 100 (or the mobile device) may be connected via a data network or electronically connected to one or more servers (for example, a security server, a resource server, a game server and/or the like). In an alternative example embodiment, the computer terminal 100 (or the mobile device) may be any mobile computing device. The connection via the data network may be connection via an LAN, connection via a wide area network (WAN), connection via the Internet, or connection via a data network of another type. The computer terminal 100 (or the mobile device) may execute a network service executed by one server (for example, the security server) or a group of servers to which the computer terminal 100 (or the mobile device) is connected. The network service is a network-based user service, such as a social network, a cloud resource, an email, an online payment, or other online applications.

With the popularity of the Internet, electronic communication is increasingly widely applied. However, a consequent issue of information security significantly becomes the main issue in the electronic communication. For the information security issue, there are many ways to reduce the possibility of information being stolen, tampered with, or replaced. For example, data is encrypted. During data transmission between two information interaction parties, the transmitting party first encrypts the data and then transmits the encrypted data to the receiving party, and the receiving party needs to decrypt the received encrypted information to obtain original data output by the transmitting party, thus effectively preventing data from being stolen, tampered with, or replaced by a third party during data transmission. In current encryption and decryption modes, an encryption algorithm and a decryption algorithm corresponding thereto may be used to implement data encryption and decryption. For example, a THSDC is used for encryption.

The THSDEC (or THSDC) may implement trusted platform guidance functions from booting and before loading of an operating system kernel; guarantee computation security in encryption and/or decryption of business-sensitive data; and during an interaction between two devices, guarantee legitimacy of their platforms and identities.

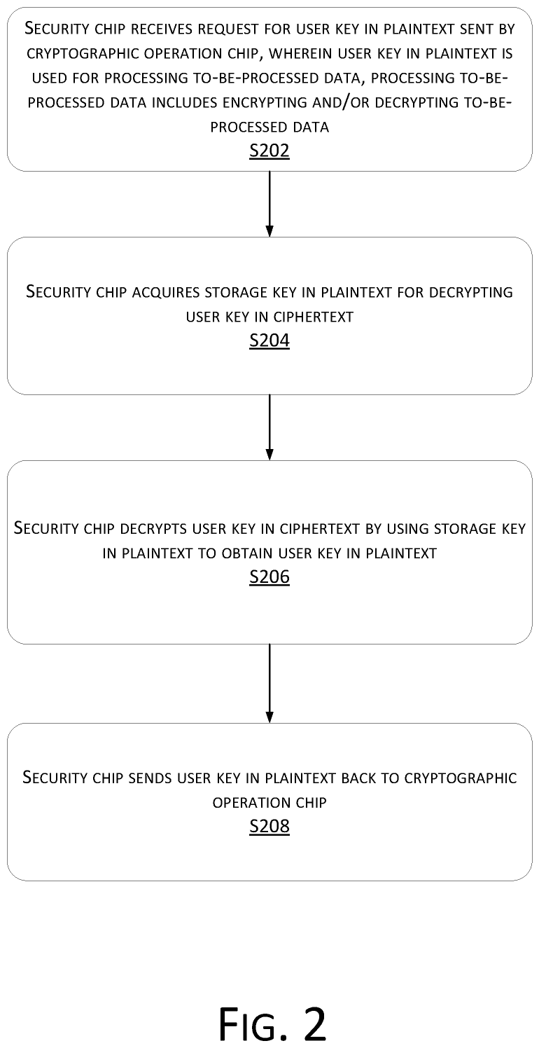

In the foregoing running environment, the present disclosure provides a data processing method shown in FIG. 2, which is a flowchart of the data processing method according to Example embodiment 1 of the present disclosure. As shown in FIG. 2, the data processing method comprises the following steps:

Step S202: A security chip receives a request for a user key in plaintext sent by a cryptographic operation chip, wherein the user key in plaintext is used for processing to-be-processed data, and the processing the to-be-processed data comprises encrypting and/or decrypting the to-be-processed data.

For example, the request for user key in plaintext may be sent to the security chip after the cryptographic operation chip receives a request for encryption and/or decryption from a user to a THSDC. The cryptographic operation request may be a request directly sent by the user to the THSDC, and the THSDC directly receives the cryptographic operation request and performs encryption and/or decryption processing corresponding to the cryptographic operation request.

For example, the cryptographic operation chip asks the security chip for the user key in plaintext, and after receiving the user key in plaintext, encrypts and/or decrypts the to-be-processed data according to the user key in plaintext.

For example, the user key in plaintext may be data, files, programs, or the like of different forms.

For example, the to-be-processed data includes to-be-encrypted data and to-be-decrypted data. The processing includes encryption processing on the to-be-encrypted data, and decryption processing on the to-be-decrypted data. The user key in plaintext includes an encryption algorithm for implementing the encryption processing on the to-be-encrypted data, and a decryption algorithm for implementing the decryption processing on the to-be-decrypted data.

For example, the processing includes encryption and/or decryption processing on the to-be-processed data, which requires a particular encryption algorithm and/or decryption algorithm, namely, the user key in plaintext. The encryption and/or decryption processing may further include encryption and/or decryption processing on the user key in plaintext.

Step S204: The security chip acquires a storage key in plaintext for decrypting a user key in ciphertext.

For example, the user key in ciphertext is obtained by encrypting the user key in plaintext. The user key in ciphertext needs to be decrypted into the user key in plaintext before being used to encrypt and/or decrypt the to-be-processed data.

For example, the encryption processing of encrypting the user key in plaintext into the user key in ciphertext requires a corresponding encryption algorithm, and the decryption processing of decrypting the user key in ciphertext into the user key in plaintext requires a corresponding decryption algorithm. The encryption algorithm and the decryption algorithm may be data, files, programs, or the like of different forms.

For example, the decryption algorithm corresponding to the foregoing decryption processing of decrypting the user key in ciphertext into the user key in plaintext may be written in the storage key in plaintext. By decrypting the user key in ciphertext by using the storage key in plaintext, the user key in plaintext may be obtained.

For example, the storage key in plaintext may be data, files, programs, or the like of different forms.

Step S206: The security chip decrypts the user key in ciphertext by using the storage key in plaintext to obtain the user key in plaintext.

For example, the foregoing decryption processing of decrypting the user key in ciphertext by using the storage key in plaintext to obtain the user key in plaintext may be performed by the security chip, or by a module or device for encrypting and/or decrypting the user key in plaintext, wherein the module or device may be located outside the security chip.

For example, the foregoing decryption processing of decrypting the user key in ciphertext by using the storage key in plaintext to obtain the user key in plaintext is performed by the security chip in this example embodiment, which avoids acquiring the storage key in plaintext from a module or device outside the security chip, and further prevents the storage key in plaintext from being tampered with during its transmission, thus effectively enhancing data encryption and/or decryption reliability.

Step S208: The security chip sends the user key in plaintext back to the cryptographic operation chip.

For example, after the security chip sends the user key in plaintext back to the cryptographic operation chip, the cryptographic operation chip encrypts and/or decrypts the to-be-processed data according to the user key in plaintext in response to the request for processing the to-be-processed data from the user.

In the example embodiments of the present disclosure, a security chip receives a request for user key in plaintext sent by a cryptographic operation chip, wherein a user key in plaintext is used for processing to-be-processed data; the security chip acquires a storage key in plaintext for decrypting a user key in ciphertext, decrypts the user key in ciphertext by using the storage key in plaintext to obtain the user key in plaintext, and then sends the user key in plaintext back to the cryptographic operation chip. By processing the user key in plaintext, the example embodiment of the present disclosure achieves a technical effect of effectively enhancing data processing security, and thus solves the technical problems in the conventional techniques of how to guarantee the security of a user key and how to prevent its exposure during transmission, such that the user key may be securely used to process user data.

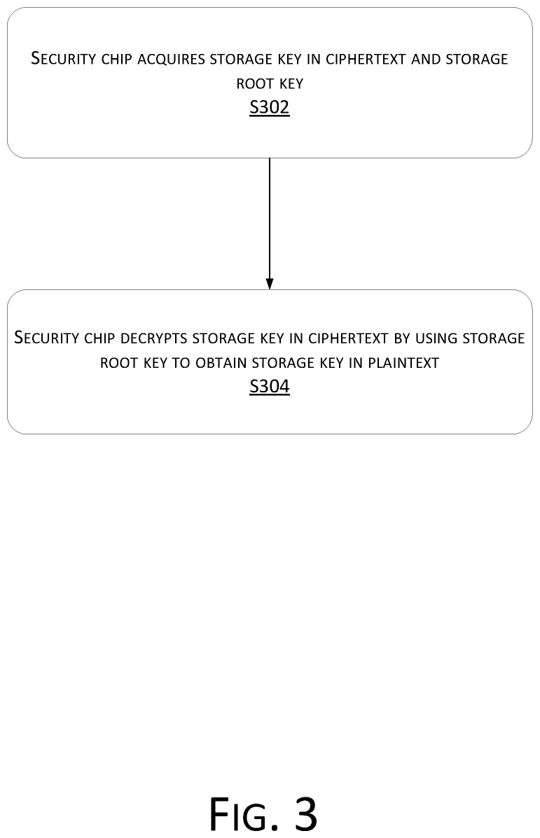

For example, FIG. 3 is a flowchart of another data processing method according to Example embodiment 1 of the present disclosure. As shown in FIG. 3, acquiring, by the security chip, a storage key in plaintext for decrypting a user key in ciphertext includes the following steps:

Step S302: The security chip acquires a storage key in ciphertext and a storage root key.

Step S304: The security chip decrypts the storage key in ciphertext by using the storage root key to obtain the storage key in plaintext.

For example, the storage key in plaintext is encrypted to obtain the storage key in ciphertext, and the storage key in ciphertext is decrypted to obtain the storage key in plaintext. The encryption processing and the decryption processing require a corresponding encryption algorithm and/or decryption algorithm, which is processed according to the storage root key.

For example, the security chip may acquire the storage key in ciphertext and the storage root key from the security chip. That is, the storage key in ciphertext and the storage root key are stored in the security chip, which may effectively enhance encryption and decryption security.

For example, the security chip decrypts the storage key in ciphertext by using the storage root key to obtain the storage key in plaintext. By processing the storage key in plaintext, security during encryption and/or decryption of the user key in ciphertext may be effectively enhanced, thus enhancing the security of the user key in plaintext.

For example, acquiring, by the security chip, a storage key in ciphertext and a storage root key includes loading, by the security chip, the storage key in ciphertext and the storage root key from a flash memory of the security chip to a memory of the security chip.

For example, the security chip loads the storage key in ciphertext and the storage root key from the flash memory of the security chip to the memory of the security chip, which may ensure long storage time of the storage key in ciphertext and the storage root key and achieve stable storage.

For example, the flash memory of the security chip receives the storage key in ciphertext and the storage root key, which achieves fast storage. Then, the security chip loads the storage key in ciphertext and the storage root key from the flash memory to the memory of the security chip for storage, which not only achieves fast storage, but also ensures long storage time and a stable storage environment.

For example, after the receiving, by the security chip, the request for user key in plaintext sent by the cryptographic operation chip, the method further comprises: loading, by the security chip, the user key in ciphertext from the cryptographic operation chip to the memory of the security chip.

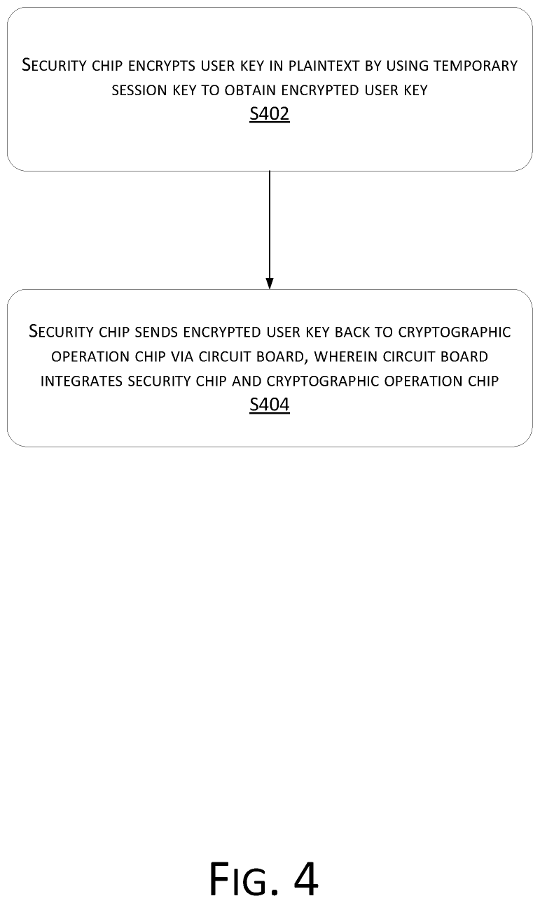

For example, FIG. 4 is a flowchart of still another data processing method according to Example embodiment 1 of the present disclosure. As shown in FIG. 4, the sending, by the security chip, the user key in plaintext back to the cryptographic operation chip includes the following steps:

Step S402: The security chip encrypts the user key in plaintext by using a temporary session key to obtain an encrypted user key.

Step S404: The security chip sends the encrypted user key back to the cryptographic operation chip via a circuit board, wherein the circuit board integrates the security chip and the cryptographic operation chip.

For example, during transmission of the user key in plaintext to the cryptographic operation chip, the security chip may also encrypt and/or decrypt this transmission process, to encrypt and/or decrypt the user key in plaintext as transmitted data, thus enhancing the security of transmission of the user key in plaintext.

For example, the security chip may perform encryption and/or decryption in many ways. For example, the security chip encrypts the user key in plaintext by using the temporary session key to obtain the encrypted user key. The temporary session method is easy and convenient and realizes fast establishment and cancellation of a transmission connection, thus improving transmission efficiency.

For example, the security chip sends the encrypted user key back to the cryptographic operation chip via the circuit board, wherein the circuit board integrates the security chip and the cryptographic operation chip. By using the original circuit board that connects the security chip and the cryptographic operation chip for transmission, the existing resource is fully utilized, and use of a new resource is avoided, thus effectively reducing energy consumption of the security chip and the cryptographic operation chip.

For example, this example embodiment provides a structure of a THSDC, which is described in detail below.

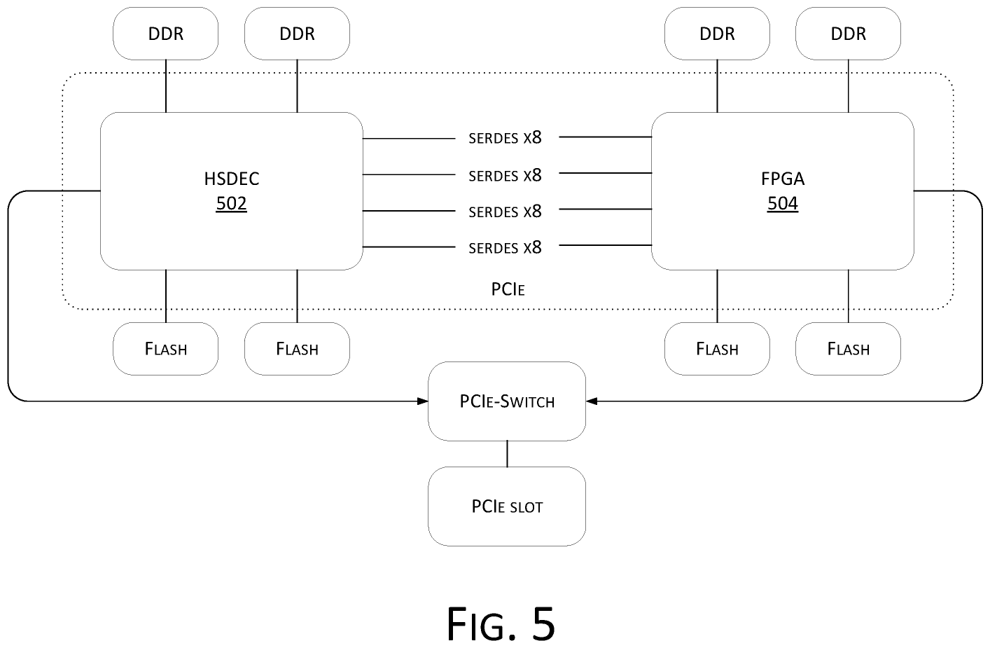

The THSDC integrates a trusted computing chip (namely, the above-mentioned security chip) and an FPGA high-speed encryption card (namely, the above-mentioned cryptographic operation chip) in one PCIE card. FIG. 5 is a structural block diagram of the THSDC according to Example embodiment 1 of the present disclosure. As shown in FIG. 5, a data interaction between the trusted computing chip HSDEC 502 and the FPGA 504 chip may be implemented directly via a circuit inside a board card, without the need to map a memory of a host. Each of the HSDEC 502 and the FPGA is associated with multiple memories including DDR and flash. The THSDC and a trusted software base (TSB) or a trusted software stack (TSS) perform a command and data interaction via a PCIE or SPI bus, and realize measurement of the BMC/BIOS and a connection to related controllers by multiplexing the GPIO/SPI/I2C with a multiplexer.

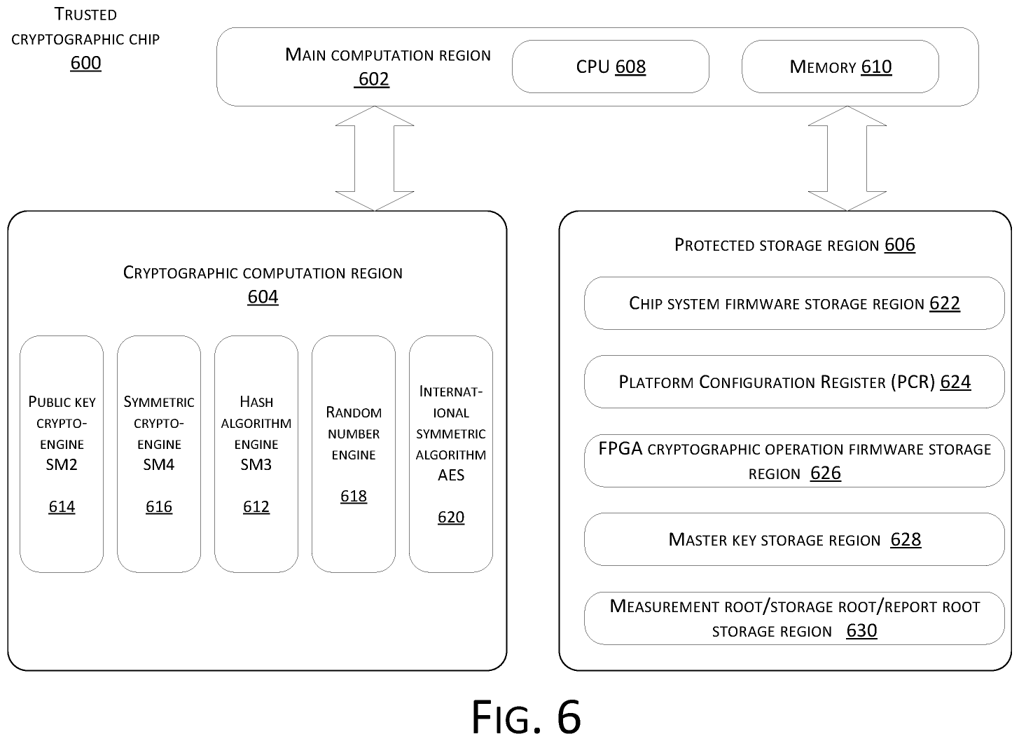

FIG. 6 is a structural block diagram of a trusted computing chip according to Example embodiment 1 of the present disclosure. As shown in FIG. 6, a trusted cryptographic chip 600 such as the trusted computing chip HSDEC is mainly composed of a main computation region 602, a cryptographic computation region 604, and a protected storage region 606. The main computation region 602 includes a CPU 608 and a memory 610 and is mainly used for general purpose computation other than a cryptographic operation, having low requirements for cryptographic computation and storage capabilities but a high security requirement. The cryptographic computation region 604 includes engines of cryptographic algorithms of different kinds, such as hash algorithm engine SM3 612, public key crypto-engine SM2 614, symmetric crypto-engine SM4 616, random number engine 618, international symmetric algorithm AES engine 620, RSA crypto-engine (not shown in FIG. 6), and is mainly used for a cryptographic operation having low requirements for cryptographic computation and storage capabilities. The protected storage region 606 is used for storage of firmware, storage of a PCR register, storage of a master key (which may be used to protect a user key generated in an FPGA chip card), storage of firmware (mainly including a cryptographic algorithm, an interface, a time sequence, a status, a buffer, and the like) related to an FPGA cryptographic operation and storage of a measurement root/report root/storage root. For example, the protected storage regions 606 includes a chip system firmware storage region 622, a platform configuration register (PCR) 624, a FPGA cryptographic operation firmware storage region 626, a master key storage region 628, and a measurement root/storage root/report root storage region 630.

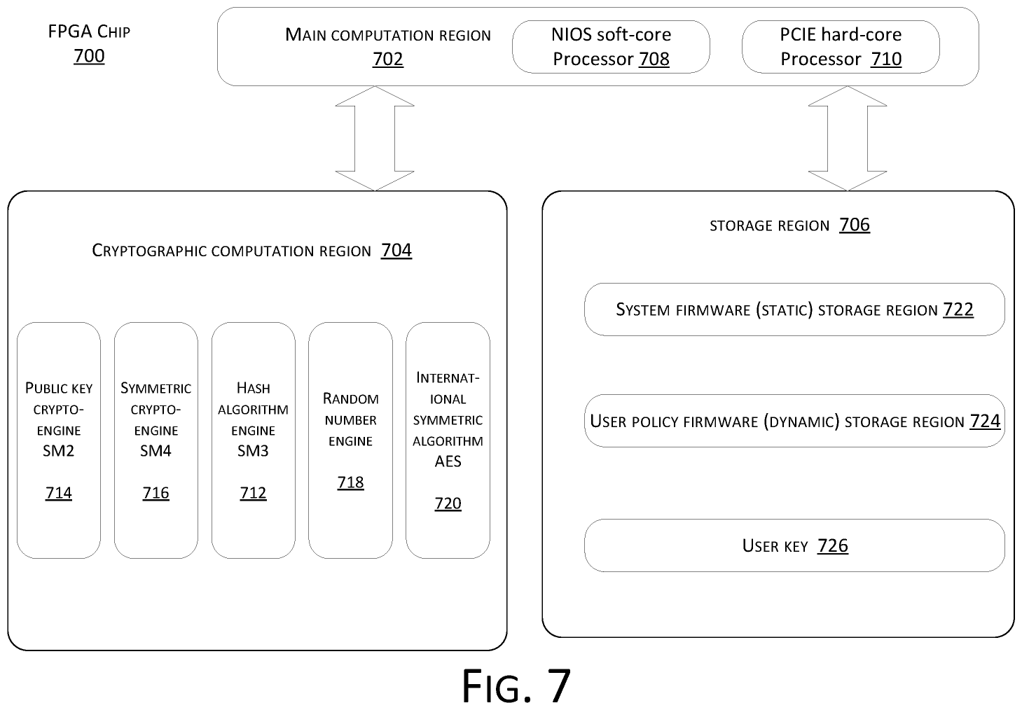

FIG. 7 is a structural block diagram of an FPGA chip 700 according to Example embodiment 1 of the present disclosure. As shown in FIG. 7, the FPGA chip 700 is mainly composed of a main computation region 702, a cryptographic operation region 704, and a storage region 706.

The main computation region 702 is composed of a NIOS soft-core processor 708 and a PCIE hard-core processor 710 of a built-in FPGA chip, which respectively implement a controller module function and an interface module function.

The cryptographic computation region 704 is mainly used for a cryptographic operation having high requirements for cryptographic computation and storage capabilities. Cryptographic algorithms thereof may be dynamically loaded in the board according to demands for actually applied cryptographic algorithms formulated based on a user policy of a dynamic user firmware storage region. Before loading of the algorithms, a root of trust for measurement is used to verify their integrity and legitimacy. For example, the cryptographic computation region 704 includes engines of cryptographic algorithms of different kinds, such as hash algorithm engine SM3 712, public key crypto-engine SM2 714, symmetric crypto-engine SM4 716, random number engine 718, international symmetric algorithm AES engine 720, RSA crypto-engine (not shown in FIG. 7)

The storage region 706 includes a static system firmware (static) storage region 722 which is readable but not writable; a user policy firmware (dynamic) storage region 724 which is readable and writable, and mainly stores dynamic policies configured by a user; and a user key 726, which is calculated by the FPGA chip 700 according to a cryptographic algorithm.

This example embodiment further provides a method for protecting data decryption based on the THSDC. During execution of the method, when the THSDC performs operations related to high-speed encryption and/or decryption, it is supposed that the equipment platform and system are integrated; user data is protected by using a user key; the user key is generated by the user by using the cryptographic operation chip of the THSDC and is protected by a user storage key (also known as a master key); the user storage key is generated by a trusted control platform or a built-in THSDC of user equipment and is protected by a storage root key of a trusted chip; the storage root key of the trusted chip already exists in the THSDC when the THSDC is delivered from a factory; the user storage key is derived from the storage root key of the THSDC; and a data interaction between the user and the THSDC is subjected to encrypted protection with public or private keys of each other, and their identities are mutually verified by using a certificate.

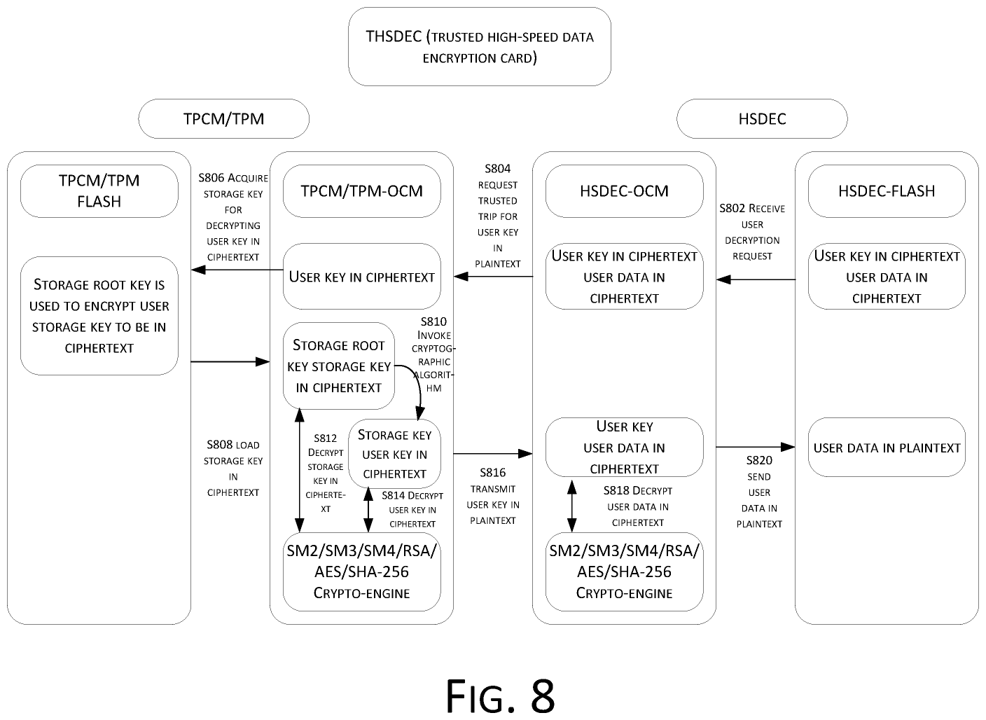

FIG. 8 is a flowchart of a method for protecting data decryption based on the THSDEC according to Example embodiment 1 of the present disclosure. As shown in FIG. 8, there are totally four entities: a user, a TSB/TSS (the TSB corresponds to a TSB of a TPCM and the TSS corresponds to a TSS of a TPM), a trusted chip (a TPM/TPCM) of the THSDC, and a high-speed cryptographic operation chip (an HSDEC). The trusted chip consists of TPM/TPCM-Flash (an internal storage of the TPM) and TPM/TPCM-Ocm (a built-in memory of the TPM). The high-speed cryptographic operation chip consists of HSDEC-Flash (an internal storage of the HSDEC) and HSDEC-Ocm (a built-in memory of the HSDEC).

The protection method of data decryption based on the THSDC in this example embodiment comprises the following steps:

Step S802. The user sends a data decryption request to the THSDC via the TSB/TSS, and an OS system of the HSDEC loads a user data in ciphertext and a user key in ciphertext from the Flash to the OCM (memory) of the high-speed cryptographic operation chip.

Step S804. The high-speed cryptographic operation chip requests the trusted chip for a user key in plaintext, and the user key in ciphertext is loaded to the OCM of the trusted chip.

Step S806. The trusted chip acquires a storage key for decrypting the user key in ciphertext.

Step S808. In order to acquire the storage key, the trusted chip loads a storage key in ciphertext from the Flash to its OCM and further loads a trusted storage root key to the OCM.

Step S810. The trusted invokes related cryptographic algorithm by using a crypto-engine.

Step S812. The trusted chip decrypts a storage key in ciphertext with the storage root key to obtain a storage key in plaintext.

Step S814. The trusted chip invokes a related cryptographic algorithm by using a crypto-engine and decrypts the user key in ciphertext by using the storage key in plaintext to obtain the user key in plaintext.

Step S816. The trusted chip transmits the user key in plaintext to the high-speed cryptographic operation chip via on-board circuits in the trusted chip and the high-speed cryptographic operation chip.

For example, in Step S816, to achieve a high level of security, the trusted chip may also first encrypt the user key in plaintext by using a user cryptographic operation measurement key temporarily negotiated with the high-speed cryptographic operation chip, and then transmitting the encrypted data to the high-speed cryptographic operation chip via the on-board circuits. In addition, the user cryptographic operation measurement key may be pre-configured to participate in measurement of algorithm firmware for a user cryptographic operation, so as to ensure credible loading and execution during dynamic measurement of the cryptographic operation.

Step S818. The high-speed cryptographic operation chip invokes a related cryptographic algorithm by using a crypto-engine and decrypts the user data in ciphertext with the user key in plaintext to obtain a user data plaintext.

For example, in S818 if the high-speed cryptographic operation chip obtains a user key in ciphertext encrypted by using a temporary session key or a measurement key, a corresponding decryption operation is further required.

Step S820. the user data is sent in plaintext and the use receives the user data in plaintext directly from Flash.

For example, in Step S820, if the decrypted data plaintext is sensitive, the data may be encrypted by using the identity of the user. After receiving the data plaintext, the user decrypts it with a private key based on his/her identity.

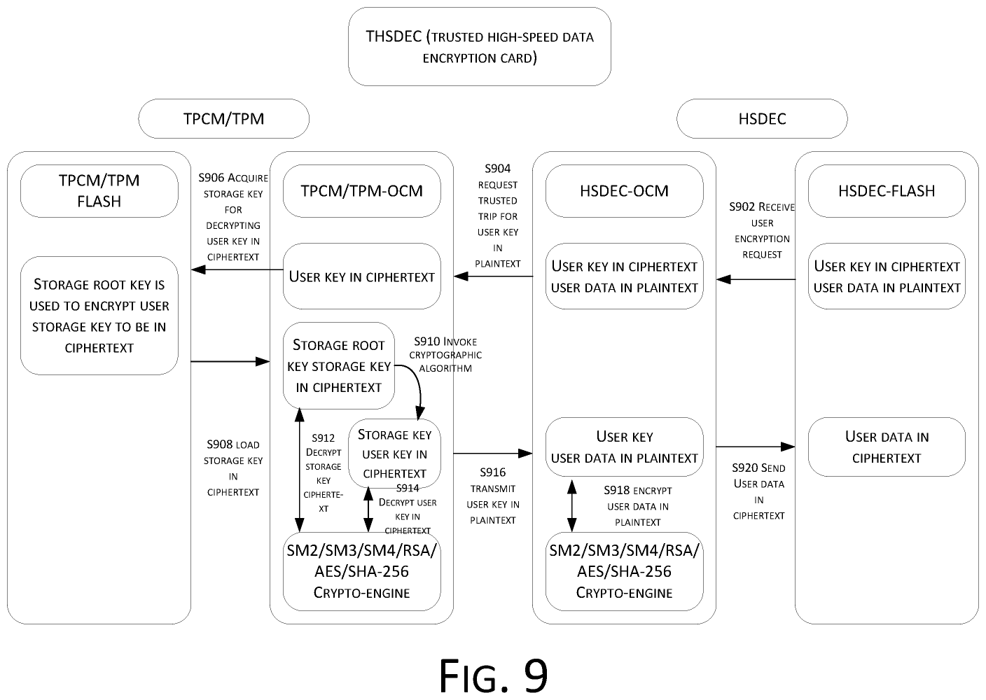

This example embodiment further provides a method for protecting data encryption based on the THSDC. FIG. 9 is a flowchart of a method for protecting data encryption based on the THSDC according to Example embodiment 1 of the present disclosure. As shown in FIG. 9, the method is similar to that in FIG. 8, and the difference is only in that the object processed at the beginning changes from a data ciphertext to a data plaintext, and thus, data processing changes from decryption to encryption. Therefore, details will be not described herein again.

Step S902. The user sends a data encryption request to the THSDC via the TSB/TSS.

Step S904. The high-speed cryptographic operation chip acquires the user key in plaintext.

Step S906. The trusted chip acquires a storage key for decrypting the user key in ciphertext.

Step S908. In order to acquire the storage key, the trusted chip loads a storage key in ciphertext from the Flash to its OCM and further loads a trusted storage root key to the OCM.

Step S910. The trusted invokes related cryptographic algorithm by using a crypto-engine.

Step S912. The trusted chip decrypts a storage key in ciphertext with the storage root key to obtain a storage key in plaintext.

Step S914. The trusted chip invokes a related cryptographic algorithm by using a crypto-engine and decrypts the user key in ciphertext by using the storage key in plaintext to obtain the user key in plaintext.

Step S916. The trusted chip transmits the user key in plaintext to the high-speed cryptographic operation chip via on-board circuits in the trusted chip and the high-speed cryptographic operation chip.

Step S918. The high-speed cryptographic operation chip invokes a related cryptographic algorithm by using a crypto-engine and encrypts the user data in plaintext with the user key in plaintext to obtain a user data plaintext.

Step S920. the user data is sent in ciphertext and the use receives the user data in ciphertext directly from Flash.

In the foregoing alternative example embodiments, the user storage key and the user key are securely protected by using the trusted chip during a high-speed cryptographic operation, which avoids an exposure risk of the user key in the high-speed cryptographic operation chip. Key-related low-speed encryption and/or decryption is implemented in the trusted chip, while a data-related high-speed cryptographic operation is performed in the high-speed cryptographic operation chip, thus guaranteeing the security of a key related to a high-speed cryptographic operation and avoiding limited data computation during encryption and/or decryption in the current trusted chip.

### Example Embodiment 2

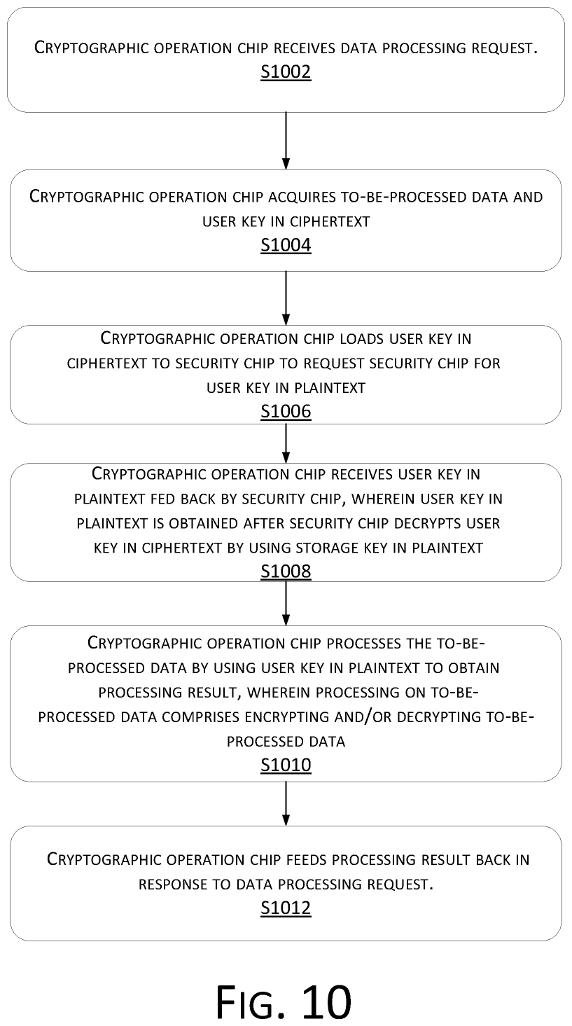

According to the example embodiment of the present disclosure, a method example embodiment of another data processing method is provided. FIG. 10 is a flowchart of a data processing method according to Example embodiment 2 of the present disclosure. As shown in FIG. 10, the data processing method comprises the following steps:

Step S1002. A cryptographic operation chip receives a data processing request.

For example, the cryptographic operation chip receives the data processing request sent by a user. The data processing request may be a request for an encryption operation from the user to a THSDC and may be directly sent by the user to the THSDC. The THSDC directly receives the request and performs the encryption operation corresponding to the data processing request.

For example, the data processing request may also be an operation request sent to the THSDC after particular processing. After the particular processing, the data processing request has optimized performance corresponding to this processing. For example, after noise removal, the data processing request may be more accurate. For another example, after being processed, the data processing request may be transmitted more securely.

For example, the data processing request may also be processed by a trusted forwarding module, which is configured to verify the legitimacy of the data processing request, namely, perform authentication on the data processing request. In the case where the authentication on the data processing request succeeds, the data processing request is forwarded to the THSDC.

Step S1004. The cryptographic operation chip acquires to-be-processed data and a user key in ciphertext.

For example, the cryptographic operation chip first needs to acquire a user key in plaintext, and then processes the to-be-processed data according to the user key in plaintext.

For example, the user key in plaintext is obtained by decrypting the user key in ciphertext. The user key in ciphertext may be stored in the cryptographic operation chip, or in a module or device, capable of storing the user key in ciphertext, other than the cryptographic operation chip.

For example, the user key in ciphertext and the to-be-processed data are both stored in the data processing request sent by the user, and share the same transmission path with the to-be-processed data. When it is determined that a data decryption request is not tampered with, it may be determined that the to-be-processed data is not tampered with.

Step S1006. The cryptographic operation chip loads the user key in ciphertext to a security chip to request the security chip for a user key in plaintext.

For example, the cryptographic operation chip transmits, to the security chip, the user key in ciphertext in the data processing request from the user; and the security chip decrypts the user key in ciphertext to obtain the user key in plaintext.

For example, the user key in plaintext may be data, files, programs, or the like of different forms.

For example, the security chip receives a request for user key in plaintext sent by the cryptographic operation chip, wherein a user key in plaintext is used for processing the to-be-processed data.

For example, the cryptographic operation chip asks the security chip for the user key in plaintext, and after receiving the user key in plaintext, processes the to-be-processed data according to the user key in plaintext.

Step S1008. The cryptographic operation chip receives the user key in plaintext fed back by the security chip, wherein the user key in plaintext is obtained after the security chip decrypts the user key in ciphertext by using a storage key in plaintext.

For example, the security chip acquires the storage key in plaintext for decrypting the user key in ciphertext and decrypts the user key in ciphertext by using the storage key in plaintext to obtain the user key in plaintext.

For example, the encryption processing of encrypting the user key in plaintext into the user key in ciphertext requires a corresponding encryption algorithm, and the decryption processing of decrypting the user key in ciphertext into the user key in plaintext requires a corresponding decryption algorithm. The encryption algorithm and the decryption algorithm may be data, files, programs, or the like of different forms.

For example, the decryption algorithm corresponding to the foregoing decryption processing of decrypting the user key in ciphertext into the user key in plaintext may be written in the storage key in plaintext. By decrypting the user key in ciphertext by using the storage key in plaintext, the user key in plaintext may be obtained.

Step S1010. The cryptographic operation chip processes the to-be-processed data by using the user key in plaintext to obtain a processing result, wherein the processing on the to-be-processed data comprises encrypting and/or decrypting the to-be-processed data.

For example, the cryptographic operation chip processes the to-be-processed data according to the user key in plaintext obtained after decryption by the security chip, which guarantees security of the user key in plaintext and thus guarantees security of the data processing.

For example, the processing result may be data, files, programs, or the like of different forms.

Step S1012. The cryptographic operation chip sends the processing result back in response to the data processing request.

For example, in response to the data processing request sent by the user, the to-be-processed data is processed to obtain the processing result; and the processing result is fed back to the user.

For example, the storage key in plaintext is obtained after the security chip decrypts a storage key in ciphertext by using a storage root key.

For example, acquiring, by the security chip, a storage key in plaintext for decrypting a user key in ciphertext includes acquiring, by the security chip, a storage key in ciphertext and a storage root key and decrypting, by the security chip, the storage key in ciphertext by using the storage root key to obtain the storage key in plaintext.

For example, the storage key in plaintext is encrypted to obtain the storage key in ciphertext, and the storage key in ciphertext is decrypted to obtain the storage key in plaintext. The encryption processing and the decryption processing require a corresponding encryption algorithm and/or decryption algorithm, which is generated according to the storage root key.

For example, the security chip may acquire the storage key in ciphertext and the storage root key from the security chip. That is, the storage key in ciphertext and the storage root key are stored in the security chip, which may effectively enhance encryption and decryption security.

For example, the security chip decrypts the storage key in ciphertext by using the storage root key to obtain the storage key in plaintext. By encrypting and/or decrypting the storage key in plaintext, security during data processing of the user key in ciphertext may be effectively enhanced, thus enhancing the security of the user key in plaintext.

For example, after the cryptographic operation chip receives the data processing request, the method further comprises: loading, by the cryptographic operation chip, the to-be-processed data and the user key in ciphertext from a flash memory of the cryptographic operation chip to a memory of the cryptographic operation chip, and loading, by the cryptographic operation chip, the user key in ciphertext from the memory of the cryptographic operation chip to a memory of the security chip.

For example, the cryptographic operation chip loads the to-be-processed data and the user key in ciphertext from the memory of the cryptographic operation chip to the memory of the security chip, which may ensure long storage time of the to-be-processed data and the user key in ciphertext and achieve stable storage.

For example, the flash memory of the cryptographic operation chip receives the to-be-processed data and the user key in ciphertext, which achieves fast storage. Then, the cryptographic operation chip loads the to-be-processed data and the user key in ciphertext from the flash memory to the memory of the cryptographic operation chip for storage, which not only achieves fast storage, but also ensures long storage time and a stable storage environment.

For example, receiving, by the cryptographic operation chip, the user key in plaintext fed back by the security chip includes: receiving, by the cryptographic operation chip, an encrypted user key sent by the security chip, wherein the encrypted user key is obtained by encrypting the user key in plaintext by using a temporary session key; and decrypting, by the cryptographic operation chip, the encrypted user key by using the temporary session key to obtain the user key in plaintext.

For example, during transmission of the user key in plaintext to the cryptographic operation chip, the security chip may also process this transmission process, to process the user key in plaintext as transmitted data, thus enhancing the security of transmission of the user key in plaintext.

For example, the security chip may perform processing in many ways. For example, the security chip encrypts the user key in plaintext by using the temporary session key to obtain the encrypted user key. The way of temporary session is easy and convenient and realizes fast establishment and cancellation of a transmission connection, thus improving transmission efficiency.

For example, the security chip sends the encrypted user key back to the cryptographic operation chip via a circuit board, wherein the circuit board integrates the security chip and the cryptographic operation chip. By using the original circuit board that connects the security chip and the cryptographic operation chip for transmission, the existing resource is fully utilized, and use of a new resource is avoided, thus effectively reducing energy consumption of the security chip and the cryptographic operation chip.

### Example Embodiment 3

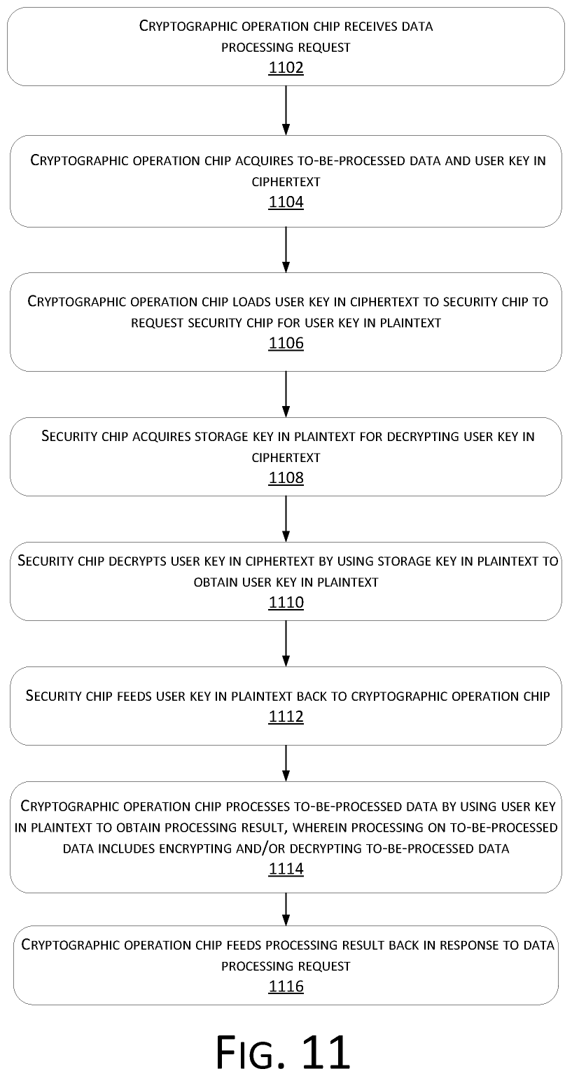

According to the example embodiment of the present disclosure, a method example embodiment of still another data processing method is provided. FIG. 11 is a flowchart of a data processing method according to Example embodiment 3 of the present disclosure. As shown in FIG. 11, the data processing method comprises the following steps:

Step S1102. A cryptographic operation chip receives a data processing request.

Step S1104. The cryptographic operation chip acquires to-be-processed data and a user key in ciphertext.

Step S1106. The cryptographic operation chip loads the user key in ciphertext to a security chip to request the security chip for a user key in plaintext.

Step S1108. The security chip acquires a storage key in plaintext for decrypting the user key in ciphertext.

Step S1110. The security chip decrypts the user key in ciphertext by using the storage key in plaintext to obtain the user key in plaintext.

Step S1112. The security chip sends the user key in plaintext back to the cryptographic operation chip.

Step S1114. The cryptographic operation chip processes the to-be-processed data by using the user key in plaintext to obtain a processing result, wherein the processing on the to-be-processed data comprises encrypting and/or decrypting the to-be-processed data.

Step S1116. The cryptographic operation chip sends the processing result back in response to the data processing request.

In the example embodiments of the present disclosure, after receiving a data processing request, a cryptographic operation chip asks a security chip for a user key in plaintext; the security chip decrypts a user key in ciphertext by using a storage key in plaintext to obtain the user key in plaintext, and then sends the user key in plaintext back to the cryptographic operation chip; and the cryptographic operation chip processes to-be-processed data by using the user key in plaintext to obtain a processing result, and sends the processing result back. By processing the user key in plaintext, the example embodiment of the present disclosure achieves a technical effect of effectively enhancing data processing security, and thus solves the technical problems in the conventional techniques of how to guarantee the security of a user key and how to prevent its exposure during transmission, such that the user key may be securely used to process user data.

For example, acquiring, by the security chip, a storage key in plaintext for decrypting a user key in ciphertext includes acquiring, by the security chip, a storage key in ciphertext and a storage root key; and decrypting, by the security chip, the storage key in ciphertext by using the storage root key to obtain the storage key in plaintext.

For example, the storage key in plaintext is encrypted to obtain the storage key in ciphertext, and the storage key in ciphertext is decrypted to obtain the storage key in plaintext. The encryption processing and the decryption processing require a corresponding encryption algorithm and/or decryption algorithm, which is implemented according to the storage root key.

For example, the security chip may acquire the storage key in ciphertext and the storage root key from the security chip. That is, the storage key in ciphertext and the storage root key are stored in the security chip, which may effectively enhance encryption and decryption security.

For example, the security chip decrypts the storage key in ciphertext by using the storage root key to obtain the storage key in plaintext. By processing the storage key in plaintext, security during data processing of the user key in ciphertext may be effectively enhanced, thus enhancing the security of the user key in plaintext. For example, for ease of description, the foregoing method example embodiments are all expressed as a combination of a series of actions. However, those skilled in the art should understand that the present disclosure is not limited by the sequence of the described actions, because some steps may be performed in another sequence or at the same time according to the present disclosure. Moreover, those skilled in the art should further understand that the example embodiments described in the description are all preferred example embodiments, and the involved actions and modules therein are not necessarily required by the present disclosure.

Based on the description of the foregoing implementations, those skilled in the art may clearly understand that the methods in the foregoing example embodiments may be implemented by means of software plus a necessary universal hardware platform, or by means of hardware. However, in many cases, the former is a better implementation. Based on such understanding, the technical solution of the present disclosure essentially or the part thereof contributing to the conventional techniques may be embodied in the form of a software product. The computer software product is stored in a storage medium (such as a ROM/RAM, a magnetic disk, or an optical disk), including instructions for instructing a terminal device (which may be a mobile phone, a computer, a server, a network device, or the like) to perform the methods in the example embodiments of the present disclosure.

### Example Embodiment 4

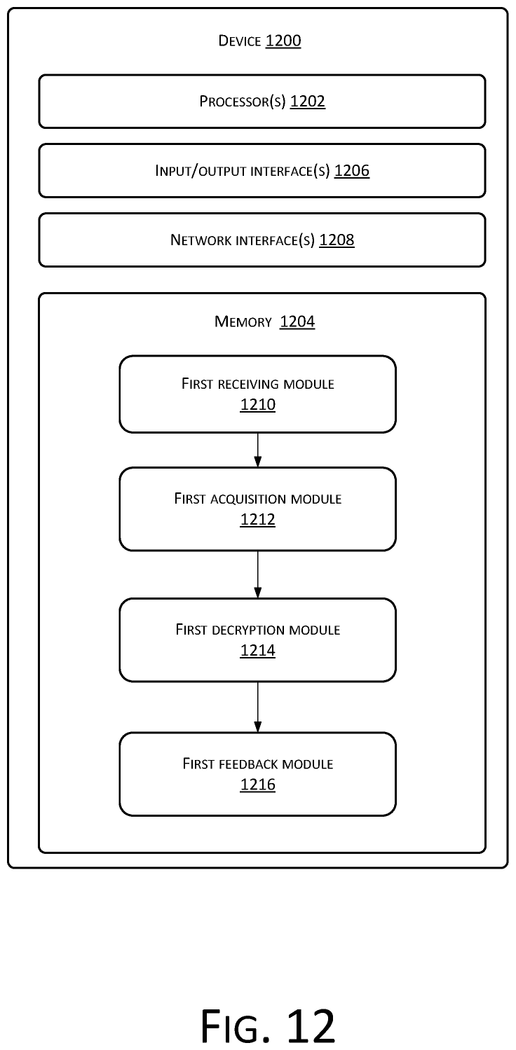

According to the example embodiment of the present disclosure, a device for implementing the data processing method in Example embodiment 1 is provided. FIG. 12 is a schematic structural diagram of a data processing device according to Example embodiment 4 of the present disclosure. As shown in FIG. 12, a device 1200 includes one or more processor(s) 1202 or data processing unit(s) and memory 1204. The device 1200 may further include one or more input/output interface(s) 1206 and one or more network interface(s) 1208. The memory 1204 is an example of computer readable medium or media.

The computer readable medium includes non-volatile and volatile media as well as movable and non-movable media, and may store information by means of any method or technology. The information may be a computer readable instruction, a data structure, and a module of a program or other data. A storage medium of a computer includes, for example, but is not limited to, a phase change memory (PRAM), a static random access memory (SRAM), a dynamic random access memory (DRAM), other types of RAMs, a ROM, an electrically erasable programmable read-only memory (EEPROM), a flash memory or other memory technologies, a compact disk read-only memory (CD-ROM), a digital versatile disc (DVD) or other optical storages, a cassette tape, a magnetic tape/magnetic disk storage or other magnetic storage devices, or any other non-transmission medium, and may be used to store information accessible to the computing device. According to the definition in this text, the computer readable medium does not include transitory media, such as a modulated data signal and a carrier.

The memory 1204 may store therein a plurality of modules or units including a first receiving module 1210, a first acquisition module 1212, a first decryption module 1214, and a first feedback module 1216.

The first receiving module 1210 is configured to receive a request for user key in plaintext sent by a cryptographic operation chip, wherein a user key in plaintext is used for processing to-be-processed data, and the processing the to-be-processed data comprises encrypting and/or decrypting the to-be-processed data. The first acquisition module 1212 is connected to the first receiving module 1210 and is configured to acquire a storage key in plaintext for decrypting a user key in ciphertext. The first decryption module 1214 is connected to the first acquisition module 1212 and is configured to decrypt the user key in ciphertext by using the storage key in plaintext to obtain the user key in plaintext. The first feedback module 1216 is connected to the first decryption module 1214 and is configured to send the user key in plaintext back to the cryptographic operation chip.

It should be noted herein that the first receiving module 1210, the first acquisition module 1212, the first decryption module 1214, and the first feedback module 1216 correspond to Steps S202 to S208 in Example embodiment 1. The four modules and corresponding steps have the same instance of implementation and the same application scenario, but the present disclosure is not limited to the content disclosed in Example embodiment 1. For example, the foregoing modules, as a part of the device, may operate in the computer terminal 10 described in Example embodiment 1.

### Example Embodiment 5

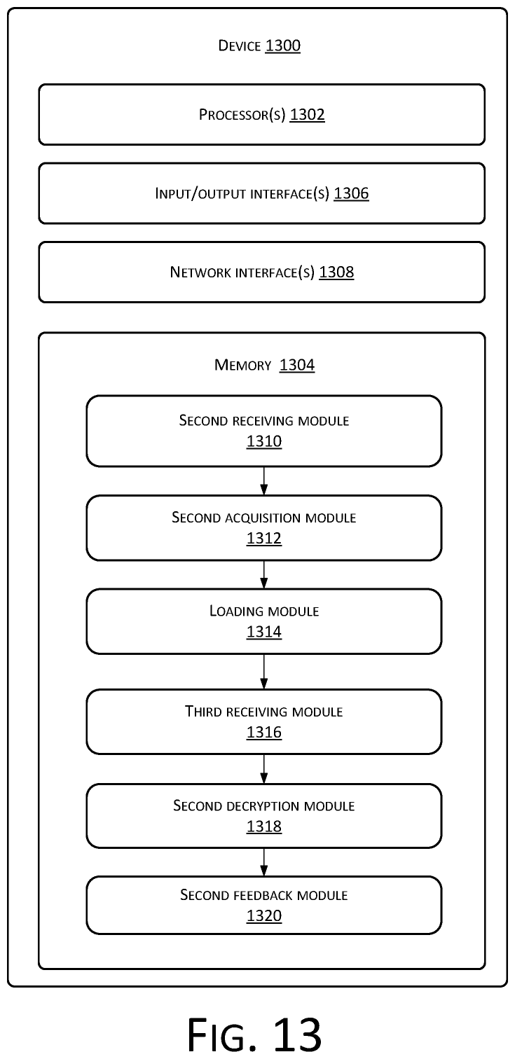

According to the example embodiment of the present disclosure, a device for implementing the data processing method in Example embodiment 1 is provided. FIG. 13 is a schematic structural diagram of a data processing device according to Example embodiment 5 of the present disclosure.

As shown in FIG. 13, a device 1300 includes one or more processor(s) 1302 or data processing unit(s) and memory 1304. The device 1300 may further include one or more input/output interface(s) 1206 and one or more network interface(s) 1308. The memory 1304 is an example of computer readable medium or media.

The memory 1304 may store therein a plurality of modules or units including a second receiving module 1310, a second acquisition module 1312, a loading module 1314, a third receiving module 1316, a second decryption module 1318, and a second feedback module 1320.

The second receiving module 1310 is configured to receive a data processing request. The second acquisition module 1312 is connected to the second receiving module 1310 and is configured to acquire to-be-processed data and a user key in ciphertext. The loading module 1314 is connected to the second acquisition module 1312 and configured to load the user key in ciphertext to a security chip, so as to ask the security chip for a user key in plaintext. The third receiving module 1316 is connected to the loading module 1314 and is configured to receive the user key in plaintext fed back by the security chip, wherein the user key in plaintext is obtained after the security chip decrypts the user key in ciphertext by using a storage key in plaintext. The second decryption module 1318 is connected to the third receiving module 1316 and is configured to process the to-be-processed data by using the user key in plaintext to obtain a processing result. The second feedback module 1320 is connected to the second decryption module 1318 and is configured to send the processing result back in response to the data processing request. The processing the to-be-processed data comprises encrypting and/or decrypting the to-be-processed data.

It should be noted herein that the second receiving module 1310, the second acquisition module 1312, the loading module 1314, the third receiving module 1316, the second decryption module 1318, and the second feedback module 1320 correspond to Steps S1002 to S1012 in Example embodiment 2. The six modules and corresponding steps have the same instance of implementation and the same application scenario, but the present disclosure is not limited to the content disclosed in Example embodiment 1. For example, the foregoing modules, as a part of the device, may operate in the computer terminal 100 described in Example embodiment 1.

### Example Embodiment 6

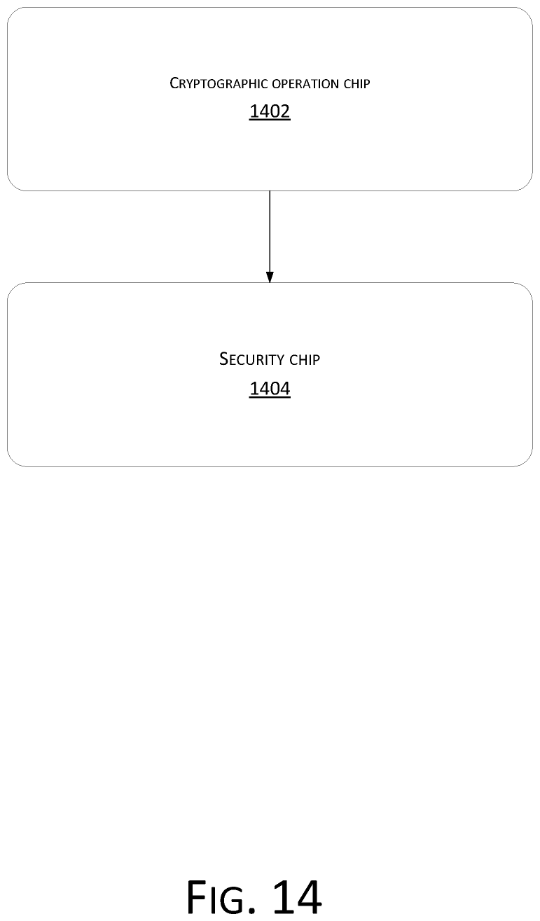

According to the example embodiment of the present disclosure, a system including the data processing devices in the foregoing example embodiments is provided. FIG. 14 is a schematic structural diagram of a data processing system according to Example embodiment 6 of the present disclosure. As shown in FIG. 14, the system comprises: a cryptographic operation chip 1402 and a security chip 1404. The system is described in detail below.

The cryptographic operation chip 1402 is configured to receive a data processing request; acquire to-be-processed data and a user key in ciphertext; and load the user key in ciphertext to the security chip to ask the security chip for a user key in plaintext. The security chip 1404 is configured to acquire a storage key in plaintext for decrypting the user key in ciphertext; decrypt the user key in ciphertext by using the storage key in plaintext to obtain the user key in plaintext; and send the user key in plaintext back to the cryptographic operation chip. The cryptographic operation chip 1402 is further configured to process the to-be-processed data by using the user key in plaintext to obtain a processing result; and send the processing result back in response to the data processing request, wherein the processing on the to-be-processed data comprises encrypting and/or decrypting the to-be-processed data.

For example, the cryptographic operation chip 1402 and the security chip 1404 have the same instance of implementation and the same application scenario with the steps of the corresponding data processing methods, or the foregoing data processing devices have the same instance of implementation and the same application scenario, but the present disclosure is not limited to the content disclosed in the foregoing example embodiments.

### Example Embodiment 7

The example embodiment of the present disclosure provides a computer terminal, which may be any computer terminal device of a group of computer terminals. For example, in this example embodiment, the computer terminal may be replaced with a mobile terminal or another terminal device.

For example, in this example embodiment, the computer terminal may be at least one network device of a plurality of network devices in a computer network.

In this example embodiment, the computer terminal may execute program codes of the following steps in an application vulnerability detection method: receiving, by a security chip, a request for user key in plaintext sent by a cryptographic operation chip, wherein a user key in plaintext is used for processing to-be-processed data, and the processing the to-be-processed data comprises encrypting and/or decrypting the to-be-processed data; acquiring, by the security chip, a storage key in plaintext for decrypting a user key in ciphertext; decrypting, by the security chip, the user key in ciphertext by using the storage key in plaintext to obtain the user key in plaintext; and sending, by the security chip, the user key in plaintext back to the cryptographic operation chip.

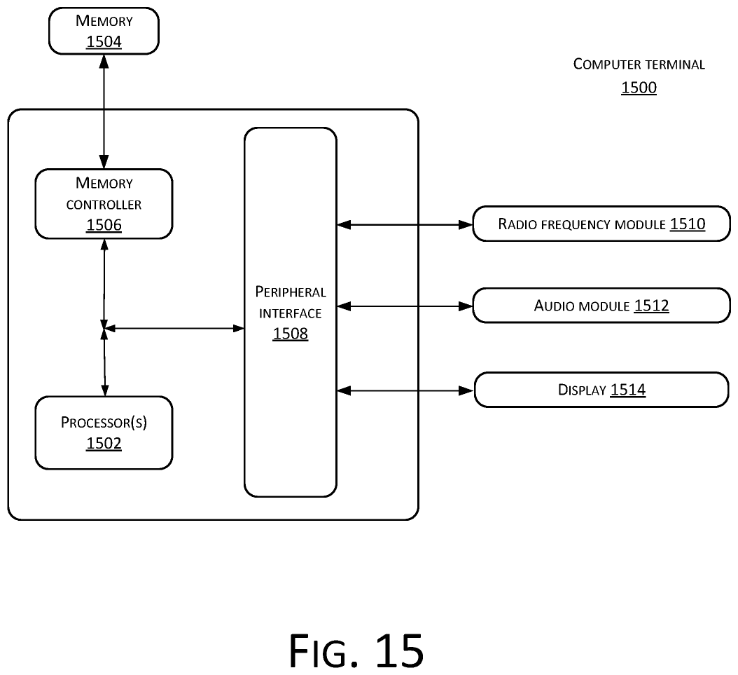

For example, FIG. 15 is a block diagram of a computer terminal configuration according to an example embodiment of the present disclosure.

As shown in FIG. 15, a computer terminal 1500 may include one or more (only one is shown in the figure) processors 1502 and a memory 1504. The memory 1504 communicated with a memory controller 1506 that interacts with the processors 1502 and a peripherical interface 1508. The peripheral interface 1508 interacts with a radio frequency module 1510, an audio module 1512, and a display 1514.

The memory 1504 may be configured to store software programs and modules, such as the program instructions/modules corresponding to the file processing method and apparatus in the example embodiments of the present disclosure. The processor 902 operates the software programs and modules stored in the memory, thus performing various functional applications and data processing, that is, implementing the above file processing method. The memory 904 may include a high-speed random-access memory and may also include a non-volatile memory, such as one or more magnetic storage apparatuses, a flash memory, or other non-volatile solid-state memories. In some examples, the memory may further include memories disposed remote to the processor. These remote memories may be connected to the terminal over a network. Examples of the network include, but are not limited to, the Internet, an intranet, a local area network, a mobile communication network, and a combination thereof.

The processor 1502 may invoke information and application programs stored in the memory by using a transmission device, so as to perform the following steps: receiving, by a security chip, a request for user key in plaintext sent by a cryptographic operation chip, wherein a user key in plaintext is used for processing to-be-processed data, and the processing the to-be-processed data comprises encrypting and/or decrypting the to-be-processed data; acquiring, by the security chip, a storage key in plaintext for decrypting a user key in ciphertext; decrypting, by the security chip, the user key in ciphertext by using the storage key in plaintext to obtain the user key in plaintext; and sending, by the security chip, the user key in plaintext back to the cryptographic operation chip.

For example, the processor 1502 may further execute a program code of the following step: the acquiring, by the security chip, a storage key in plaintext for decrypting a user key in ciphertext including: acquiring, by the security chip, a storage key in ciphertext and a storage root key; and decrypting, by the security chip, the storage key in ciphertext by using the storage root key to obtain the storage key in plaintext.

For example, the processor 1502 may further execute a program code of the following step: the acquiring, by the security chip, a storage key in ciphertext and a storage root key including loading, by the security chip, the storage key in ciphertext and the storage root key from a flash memory of the security chip to a memory of the security chip.

For example, the processor 1502 may further execute a program code of the following step: after the security chip receives the request for user key in plaintext sent by the cryptographic operation chip, further comprising: loading, by the security chip, the user key in ciphertext from the cryptographic operation chip to the memory of the security chip.

For example, the processor 1502 may further execute a program code of the following step: the sending, by the security chip, the user key in plaintext back to the cryptographic operation chip including: encrypting, by the security chip, the user key in plaintext by using a temporary session key to obtain an encrypted user key; and sending, by the security chip, the encrypted user key back to the cryptographic operation chip via a circuit board, wherein the circuit board integrates the security chip and the cryptographic operation chip.

For example, the processor 1502 may further execute a program code of the following step: another data processing method, comprising: receiving, by a cryptographic operation chip, a data processing request; acquiring, by the cryptographic operation chip, to-be-processed data and a user key in ciphertext; loading, by the cryptographic operation chip, the user key in ciphertext to a security chip to ask the security chip for a user key in plaintext; receiving, by the cryptographic operation chip, the user key in plaintext fed back by the security chip, wherein the user key in plaintext is obtained after the security chip decrypts the user key in ciphertext by using a storage key in plaintext; processing, by the cryptographic operation chip, the to-be-processed data by using the user key in plaintext to obtain a processing result, wherein the processing the to-be-processed data comprises encrypting and/or decrypting the to-be-processed data; and sending, by the cryptographic operation chip, the processing result back in response to the data processing request.

For example, the processor 1502 may further execute a program code of the following step: the storage key in plaintext being obtained after the security chip decrypts a storage key in ciphertext by using a storage root key.

For example, the processor 1502 may further execute a program code of the following step: after the cryptographic operation chip receives the data processing request, further comprising: loading, by the cryptographic operation chip, the to-be-processed data and the user key in ciphertext from a flash memory of the cryptographic operation chip to a memory of the cryptographic operation chip, and loading, by the cryptographic operation chip, the user key in ciphertext from the memory of the cryptographic operation chip to a memory of the security chip.

For example, the processor 1502 may further execute a program code of the following step: the receiving, by the cryptographic operation chip, the user key in plaintext fed back by the security chip including: receiving, by the cryptographic operation chip, an encrypted user key sent by the security chip, wherein the encrypted user key is obtained by encrypting the user key in plaintext by using a temporary session key; and decrypting, by the cryptographic operation chip, the encrypted user key by using the temporary session key to obtain the user key in plaintext.

For example, the processor 1502 may further execute a program code of the following step: a data processing method, comprising: receiving, by a cryptographic operation chip, a data processing request; acquiring, by the cryptographic operation chip, to-be-processed data and a user key in ciphertext; loading, by the cryptographic operation chip, the user key in ciphertext to a security chip to ask the security chip for a user key in plaintext; acquiring, by the security chip, a storage key in plaintext for decrypting a user key in ciphertext; decrypting, by the security chip, the user key in ciphertext by using the storage key in plaintext to obtain the user key in plaintext; and sending, by the security chip, the user key in plaintext back to the cryptographic operation chip; processing, by the cryptographic operation chip, the to-be-processed data by using the user key in plaintext to obtain a processing result; and sending, by the cryptographic operation chip, the processing result back in response to the data processing request, wherein the processing the to-be-processed data comprises encrypting and/or decrypting the to-be-processed data.

For example, the processor 1502 may further execute a program code of the following step: the acquiring, by the security chip, a storage key in plaintext for decrypting a user key in ciphertext including: acquiring, by the security chip, a storage key in ciphertext and a storage root key; and decrypting, by the security chip, the storage key in ciphertext by using the storage root key to obtain the storage key in plaintext.

In the example embodiments of the present disclosure, a solution of a data processing method is provided. A security chip receives a request for user key in plaintext sent by a cryptographic operation chip, wherein a user key in plaintext is used for processing to-be-processed data; the security chip acquires a storage key in plaintext for decrypting a user key in ciphertext, decrypts the user key in ciphertext by using the storage key in plaintext to obtain the user key in plaintext, and then sends the user key in plaintext back to the cryptographic operation chip. Thus, data processing security may be effectively enhanced, and the technical problem in the conventional techniques how to guarantee the security of a user key and how to prevent its exposure during transmission are solved, such that the user key may be securely used to process user data.

Those of ordinary skill in the art may understand that the structure shown in FIG. 15 is merely illustrative, and the computer terminal may also be a terminal device such as a smart phone (for example, an Android mobile phone or iOS mobile phone), a tablet computer, a handheld computer, a Mobile Internet Device (MID), or a PAD. FIG. 15 does not pose a limitation on the structure of the foregoing electronic device. For example, the computer terminal 100 may further include more (for example, the computer terminal further includes a network interface, a display device, and the like) or fewer components than the structure shown in FIG. 15 or have a configuration different from that in FIG. 15.

Those of ordinary skill in the art may understand that all or some of the steps in the methods in the foregoing example embodiments may be implemented by a program instructing hardware related to a terminal device. The program may be stored in a computer readable storage medium, such as a flash disk, a Read-Only Memory (ROM), a RAM, a magnetic disk, or an optical disk.

### Example Embodiment 8

The example embodiment of the present disclosure also provides a storage medium. For example, the storage medium is computer readable medium. For example, in this example embodiment, the storage medium may be configured to store program codes executed in the data processing method provided in Example embodiment 1.

For example, in this example embodiment, the storage medium may be located in any computer terminal of a group of computer terminals in a computer network or located in any mobile terminal of a group of mobile terminals.

For example, in this example embodiment, the storage medium is configured to store program codes for performing the following steps: receiving, by a security chip, a request for user key in plaintext sent by a cryptographic operation chip, wherein a user key in plaintext is used for processing to-be-processed data, and the processing the to-be-processed data comprises encrypting and/or decrypting the to-be-processed data; acquiring, by the security chip, a storage key in plaintext for decrypting a user key in ciphertext; decrypting, by the security chip, the user key in ciphertext by using the storage key in plaintext to obtain the user key in plaintext; and sending, by the security chip, the user key in plaintext back to the cryptographic operation chip.

For example, in this example embodiment, the storage medium is configured to store a program code for performing the following step: the acquiring, by the security chip, a storage key in plaintext for decrypting a user key in ciphertext including: acquiring, by the security chip, a storage key in ciphertext and a storage root key; and decrypting, by the security chip, the storage key in ciphertext by using the storage root key to obtain the storage key in plaintext.

For example, in this example embodiment, the storage medium is configured to store a program code for performing the following step: the acquiring, by the security chip, a storage key in ciphertext and a storage root key including: loading, by the security chip, the storage key in ciphertext and the storage root key from a flash memory of the security chip to a memory of the security chip.

For example, in this example embodiment, the storage medium is configured to store a program code for performing the following step: after the security chip receives the request for user key in plaintext sent by the cryptographic operation chip, further comprising: loading, by the security chip, the user key in ciphertext from the cryptographic operation chip to the memory of the security chip.

For example, in this example embodiment, the storage medium is configured to store a program code for performing the following step: the sending, by the security chip, the user key in plaintext back to the cryptographic operation chip including: encrypting, by the security chip, the user key in plaintext by using a temporary session key to obtain an encrypted user key; and sending, by the security chip, the encrypted user key back to the cryptographic operation chip via a circuit board, wherein the circuit board integrates the security chip and the cryptographic operation chip.

For example, in this example embodiment, the storage medium is configured to store a program code for performing the following step: another data processing method, comprising: receiving, by a cryptographic operation chip, a data processing request; acquiring, by the cryptographic operation chip, to-be-processed data and a user key in ciphertext; loading, by the cryptographic operation chip, the user key in ciphertext to a security chip to ask the security chip for a user key in plaintext; receiving, by the cryptographic operation chip, the user key in plaintext fed back by the security chip, wherein the user key in plaintext is obtained after the security chip decrypts the user key in ciphertext by using a storage key in plaintext; processing, by the cryptographic operation chip, the to-be-processed data by using the user key in plaintext to obtain a processing result, wherein the processing the to-be-processed data comprises encrypting and/or decrypting the to-be-processed data; and sending, by the cryptographic operation chip, the processing result back in response to the data processing request.

For example, in this example embodiment, the storage medium is configured to store a program code for performing the following step: the storage key in plaintext being obtained after the security chip decrypts a storage key in ciphertext by using a storage root key.

For example, in this example embodiment, the storage medium is configured to store a program code for performing the following step: after the cryptographic operation chip receives the data processing request, further comprising: loading, by the cryptographic operation chip, the to-be-processed data and the user key in ciphertext from a flash memory of the cryptographic operation chip to a memory of the cryptographic operation chip, and loading, by the cryptographic operation chip, the user key in ciphertext from the memory of the cryptographic operation chip to a memory of the security chip.

For example, in this example embodiment, the storage medium is configured to store a program code for performing the following step: the receiving, by the cryptographic operation chip, the user key in plaintext fed back by the security chip including: receiving, by the cryptographic operation chip, an encrypted user key sent by the security chip, wherein the encrypted user key is obtained by encrypting the user key in plaintext by using a temporary session key; and decrypting, by the cryptographic operation chip, the encrypted user key by using the temporary session key to obtain the user key in plaintext.

For example, in this example embodiment, the storage medium is configured to store a program code for performing the following step: a data processing method, comprising: receiving, by a cryptographic operation chip, a data processing request; acquiring, by the cryptographic operation chip, to-be-processed data and a user key in ciphertext; loading, by the cryptographic operation chip, the user key in ciphertext to a security chip to ask the security chip for a user key in plaintext; acquiring, by the security chip, a storage key in plaintext for decrypting a user key in ciphertext; decrypting, by the security chip, the user key in ciphertext by using the storage key in plaintext to obtain the user key in plaintext; and sending, by the security chip, the user key in plaintext back to the cryptographic operation chip; processing, by the cryptographic operation chip, the to-be-processed data by using the user key in plaintext to obtain a processing result, wherein the processing the to-be-processed data comprises encrypting and/or decrypting the to-be-processed data; and sending, by the cryptographic operation chip, the processing result back in response to the data processing request.

For example, in this example embodiment, the storage medium is configured to store a program code for performing the following step: the acquiring, by the security chip, a storage key in plaintext for decrypting a user key in ciphertext including: acquiring, by the security chip, a storage key in ciphertext and a storage root key; and decrypting, by the security chip, the storage key in ciphertext by using the storage root key to obtain the storage key in plaintext.

The serial numbers of the foregoing example embodiments of the present disclosure are merely for the convenience of description, and do not imply the preference order among the example embodiments.

In the above example embodiments of the present disclosure, the description of each example embodiment has its own emphasis. For content that is not detailed in one example embodiment, reference may be made to related description in other example embodiments.

It should be understood that the disclosed technical content in the several example embodiments provided by the present disclosure may be implemented in other manners. The device example embodiments described above are merely illustrative. For example, the units are classified merely according to their logical functions and may be classified in other manners during actual implementation. For example, multiple units or components may be combined or integrated into another system, or some features may be omitted or not implemented. In addition, the shown or discussed mutual coupling or direct coupling or communicative connection may be indirect coupling or communicative connection through some interfaces, units or modules in an electrical form or other forms.

Units described as separate parts may or may not be physically separate. A part displayed as a unit may or may not be a physical unit, that is, the part may be located at one place or distributed on multiple network units. Some or all units may be selected according to an actual requirement to achieve the objective of the solution of the example embodiment.

In addition, functional units in the example embodiments of the present disclosure may be integrated into one processing unit, or each unit may physically exist separately, or two or more units are integrated into one unit. The integrated units may be implemented in the form of hardware or a software function unit.

If the integrated units are implemented in the form of a software function unit and are sold or used as a standalone product, they may be stored in a computer readable storage medium. Based on such understanding, the technical solution of the present disclosure essentially or the part thereof contributing to the conventional techniques may be completely or partially embodied in the form of a software product. The computer software product is stored in a storage medium, including instructions for instructing a computer device (which may be a personal computer, a server, a network device, or the like) to perform all or some steps of the methods in the example embodiments of the present disclosure. The storage medium is a medium capable of storing program codes, such as a USB flash drive, a ROM, a RAM, a mobile hard disk, a magnetic disk, or an optical disk.

The above merely describes preferred example embodiments of the present disclosure. It should be noted that several improvements and modifications may be made by those of ordinary skill in the art without departing from the principle of the present disclosure, and these improvements and modifications should also be considered within the protection scope of the present disclosure.

The present disclosure may further be understood with clauses as follows.

Clause 1. A data processing method, comprising:

receiving, by a security chip, a request for user key in plaintext sent by a cryptographic operation chip, wherein the user key in plaintext is used for processing to-be-processed data, and the processing to-be-processed data comprises encrypting and/or decrypting the to-be-processed data;

acquiring, by the security chip, a storage key in plaintext for decrypting a user key in ciphertext;

decrypting, by the security chip, the user key in ciphertext by using the storage key in plaintext to obtain the user key in plaintext; and

sending, by the security chip, the user key in plaintext back to the cryptographic operation chip.

Clause 2. The method according to clause 1, wherein the acquiring, by the security chip, a storage key in plaintext for decrypting a user key in ciphertext comprises:

acquiring, by the security chip, a storage key in ciphertext and a storage root key; and

decrypting, by the security chip, the storage key in ciphertext by using the storage root key to obtain the storage key in plaintext.

Clause 3. The method according to clause 1, wherein the acquiring, by the security chip, a storage key in ciphertext and a storage root key comprises:

loading, by the security chip, the storage key in ciphertext and the storage root key from a flash memory of the security chip to a memory of the security chip.

Clause 4. The method according to clause 1, wherein after the security chip receives the request for user key in plaintext sent by the cryptographic operation chip, the method further comprises:

loading, by the security chip, the user key in ciphertext from the cryptographic operation chip to a memory of the security chip.

Clause 5. The method according to any one of clauses 1 to 4, wherein the sending, by the security chip, the user key in plaintext back to the cryptographic operation chip comprises:

encrypting, by the security chip, the user key in plaintext by using a temporary session key to obtain an encrypted user key; and

sending, by the security chip, the encrypted user key back to the cryptographic operation chip via a circuit board, wherein the circuit board integrates the security chip and the cryptographic operation chip.

Clause 6. A data processing method, comprising:

receiving, by a cryptographic operation chip, a data processing request;

acquiring, by the cryptographic operation chip, to-be-processed data and a user key in ciphertext;

loading, by the cryptographic operation chip, the user key in ciphertext to a security chip to ask the security chip for a user key in plaintext;

receiving, by the cryptographic operation chip, the user key in plaintext fed back by the security chip, wherein the user key in plaintext is obtained after the security chip decrypts the user key in ciphertext by using a storage key in plaintext;

processing, by the cryptographic operation chip, the to-be-processed data by using the user key in plaintext to obtain a processing result, wherein the processing the to-be-processed data comprises encrypting and/or decrypting the to-be-processed data; and

sending, by the cryptographic operation chip, the processing result back in response to the data processing request.

Clause 7. The method according to clause 6, wherein the storage key in plaintext is obtained after the security chip decrypts a storage key in ciphertext by using a storage root key.

Clause 8. The method according to clause 6, wherein after the cryptographic operation chip receives the data processing request, the method further comprises:

loading, by the cryptographic operation chip, the to-be-processed data and the user key in ciphertext from a flash memory of the cryptographic operation chip to a memory of the cryptographic operation chip, and loading, by the cryptographic operation chip, the user key in ciphertext from the memory of the cryptographic operation chip to a memory of the security chip.

Clause 9. The method according to any one of clauses 6 to 8, wherein the receiving, by the cryptographic operation chip, the user key in plaintext fed back by the security chip comprises:

receiving, by the cryptographic operation chip, an encrypted user key sent by the security chip, wherein the encrypted user key is obtained by encrypting the user key in plaintext by using a temporary session key; and

decrypting, by the cryptographic operation chip, the encrypted user key by using the temporary session key to obtain the user key in plaintext.

Clause 10. A data processing method, comprising:

receiving, by a cryptographic operation chip, a data processing request;

acquiring, by the cryptographic operation chip, to-be-processed data and a user key in ciphertext;

loading, by the cryptographic operation chip, the user key in ciphertext to a security chip to ask the security chip for a user key in plaintext;

acquiring, by the security chip, a storage key in plaintext for decrypting the user key in ciphertext;

decrypting, by the security chip, the user key in ciphertext by using the storage key in plaintext to obtain the user key in plaintext;

sending, by the security chip, the user key in plaintext back to the cryptographic operation chip;

processing, by the cryptographic operation chip, the to-be-processed data by using the user key in plaintext to obtain a processing result, wherein the processing the to-be-processed data comprises encrypting and/or decrypting the to-be-processed data; and

sending, by the cryptographic operation chip, the processing result back in response to the data processing request.

Clause 11. The method according to clause 10, wherein the acquiring, by the security chip, a storage key in plaintext for decrypting the user key in ciphertext comprises:

acquiring, by the security chip, a storage key in ciphertext and a storage root key; and

decrypting, by the security chip, the storage key in ciphertext by using the storage root key to obtain the storage key in plaintext.

Clause 12. A data processing device applied in a security chip, comprising:

a first receiving module configured to receive a request for user key in plaintext sent by a cryptographic operation chip, wherein the user key in plaintext is used for processing to-be-processed data, and the processing to-be-processed data comprises encrypting and/or decrypting the to-be-processed data;

a first acquisition module configured to acquire a storage key in plaintext for decrypting a user key in ciphertext;

a first decryption module configured to decrypt the user key in ciphertext by using the storage key in plaintext to obtain the user key in plaintext; and

a first feedback module configured to send the user key in plaintext back to the cryptographic operation chip.

Clause 13. A data processing device applied in a cryptographic operation chip, comprising:

a second receiving module configured to receive a data processing request;

a second acquisition module configured to acquire to-be-processed data and a user key in ciphertext;

a loading module configured to load the user key in ciphertext to a security chip, so as to ask the security chip for a user key in plaintext;

a third receiving module configured to receive the user key in plaintext fed back by the security chip, wherein the user key in plaintext is obtained after the security chip decrypts the user key in ciphertext by using a storage key in plaintext;

a second decryption module configured to process the to-be-processed data by using the user key in plaintext to obtain a processing result, wherein the processing on the to-be-processed data comprises encrypting and/or decrypting the to-be-processed data; and

a second feedback module configured to send the processing result back in response to the data processing request.

Clause 14. A data processing system, comprising a cryptographic operation chip and a security chip, wherein

the cryptographic operation chip is configured to receive a data processing request; acquire to-be-processed data and a user key in ciphertext; and load the user key in ciphertext to the security chip to ask the security chip for a user key in plaintext;

the security chip is configured to acquire a storage key in plaintext for decrypting the user key in ciphertext; decrypt the user key in ciphertext by using the storage key in plaintext to obtain the user key in plaintext; and send the user key in plaintext back to the cryptographic operation chip; and

the cryptographic operation chip is further configured to process the to-be-processed data by using the user key in plaintext to obtain a processing result; and send the processing result back in response to the data processing request, wherein the processing on the to-be-processed data comprises encrypting and/or decrypting the to-be-processed data.

Clause 15. A storage medium comprising a stored program, wherein when the program runs, a device in which the storage medium is located is controlled to perform the data processing method according to any one of clauses 1 to 11.

Clause 16. A processor configured to run a program, wherein when the program runs, the data processing method according to any one of clauses 1 to 11 is performed.

Clause 17. A computing device, comprising at least one processor and a memory storing program instructions, wherein the program instructions are adapted to be executed by the at least one processor, and are used to perform the data processing method according to any one of clauses 1 to 11.

What is claimed is:

1. A method comprising:
receiving, by a security chip, a request for a user key, sent by a cryptographic operation chip, the user key being used for processing to-be-processed data;
acquiring, by the security chip, a storage key for decrypting the user key;
decrypting, by the security chip, the user key by using the storage key to obtain a decrypted user key; and
sending, by the security chip, the decrypted user key to the cryptographic operation chip.

2. The method of claim 1, wherein the processing the to-be-processed data comprises encrypting or decrypting the to-be-processed data.

3. The method of claim 1, wherein the acquiring, by the security chip, the storage key for decrypting the user key comprises:
acquiring, by the security chip, a storage key in ciphertext and a storage root key; and
decrypting, by the security chip, the storage key in ciphertext by using the storage root key to obtain the storage key in plaintext.

4. The method of claim 3, wherein the acquiring, by the security chip, the storage key in ciphertext and the storage root key comprises:
loading, by the security chip, the storage key in ciphertext and the storage root key from a flash memory of the security chip to a memory of the security chip.

5. The method of claim 1, wherein after the security chip receives the request for the user key sent by the cryptographic operation chip, the method further comprises:
loading, by the security chip, the user key in ciphertext from the cryptographic operation chip to a memory of the security chip.

6. The method of claim 1, wherein the sending, by the security chip, the decrypted user key to the cryptographic operation chip comprises:
encrypting, by the security chip, the user key in plaintext by using a temporary session key to obtain an encrypted user key; and
sending, by the security chip, the encrypted user key to the cryptographic operation chip.

7. The method of claim 6, wherein the sending, by the security chip, the encrypted user key to the cryptographic operation chip comprises:
sending, by the security chip, the encrypted user key to the cryptographic operation chip via a circuit board, wherein the circuit board integrates the security chip and the cryptographic operation chip.

8. The method of claim 1, wherein the decrypting, by the security chip, the user key by using the storage key to obtain the decrypted user key comprises:
decrypting, by the security chip, the user key in ciphertext by using the storage key to obtain the user key in plaintext.

9. A device comprising:
one or more processors; and
one or more memories storing computer readable instructions that, executable by the one or more processors, cause the one or more processors to perform acts comprising:
receiving, by a cryptographic operation chip, a data processing request;
acquiring, by the cryptographic operation chip, to-be-processed data and an encrypted user key;
loading, by the cryptographic operation chip, the encrypted user key to a security chip to request the security chip for a decrypted user key;
receiving, by the cryptographic operation chip, the decrypted user key fed back by the security chip;
processing, by the cryptographic operation chip, the to-be-processed data by using the decrypted user key to obtain a processing result; and
returning, by the cryptographic operation chip, the processing result in response to the data processing request.

10. The device of claim 9, wherein the decrypted user key is obtained after the security chip decrypts a user key in ciphertext by using a storage key in plaintext.

11. The device of claim 10, wherein a storage key in plaintext is obtained after the security chip decrypts a storage key in ciphertext by using a storage root key.

12. The device of claim 9, wherein after the cryptographic operation chip receives the data processing request, the acts further comprise:
loading, by the cryptographic operation chip, the to-be-processed data and the encrypted user key from a flash memory of the cryptographic operation chip to a memory of the cryptographic operation chip; and
loading, by the cryptographic operation chip, the encrypted user key from the memory of the cryptographic operation chip to a memory of the security chip.

13. The device of claim 9, wherein the receiving, by the cryptographic operation chip, the decrypted user key fed back by the security chip comprises:
receiving, by the cryptographic operation chip, the encrypted user key sent by the security chip, wherein the encrypted user key is obtained by encrypting a user key in plaintext by using a temporary session key; and
decrypting, by the cryptographic operation chip, the encrypted user key by using the temporary session key to obtain the user key in plaintext.

14. One or more memories storing computer readable instructions that, executable by one or more processors, cause the one or more processors to perform acts comprising:
receiving, by a security chip, a request for a user key, sent by a cryptographic operation chip, the user key being used for processing to-be-processed data;
acquiring, by the security chip, a storage key for decrypting the user key;
decrypting, by the security chip, the user key by using the storage key to obtain a decrypted user key; and
sending, by the security chip, the decrypted user key to the cryptographic operation chip.

15. The one or more memories of claim 14, wherein the processing the to-be-processed data comprises encrypting or decrypting the to-be-processed data.

16. The one or more memories of claim 14, wherein the acquiring, by the security chip, the storage key in plaintext for decrypting the user key in ciphertext comprises:
acquiring, by the security chip, a storage key in ciphertext and a storage root key; and
decrypting, by the security chip, the storage key in ciphertext by using the storage root key to obtain the storage key in plaintext.

17. The one or more memories of claim 16, wherein the acquiring, by the security chip, the storage key in ciphertext and the storage root key comprises:
loading, by the security chip, the storage key in ciphertext and the storage root key from a flash memory of the security chip to a memory of the security chip.

18. The one or more memories of claim 14, wherein after the security chip receives the request for the user key sent by the cryptographic operation chip, the acts further comprise:
loading, by the security chip, the user key in ciphertext from the cryptographic operation chip to a memory of the security chip.

19. The one or more memories of claim 14, wherein
the sending, by the security chip, the decrypted user key to the cryptographic operation chip comprises:
encrypting, by the security chip, the user key in plaintext by using a temporary session key to obtain an encrypted user key; and
sending, by the security chip, the encrypted user key to the cryptographic operation chip.

20. The one or more memories of claim 14, wherein the sending, by the security chip, the encrypted user key to the cryptographic operation chip comprises:
sending, by the security chip, the encrypted user key to the cryptographic operation chip via a circuit board, wherein the circuit board integrates the security chip and the cryptographic operation chip.
